(19) United States
(12) Patent Application Publication
(10) Pub. No.: US 2025/0122631 A1
(43) Pub. Date: Apr. 17, 2025

(54) A METHOD AND CELL FOR REDUCING DINITROGEN TO AMMONIA

(71) Applicant: MONASH UNIVERSITY, Clayton, Victoria (AU)

(72) Inventors: Douglas R. MACFARLANE, Clayton, Victoria (AU); Alexandr Nikolaevich SIMONOV, Clayton, Victoria (AU); Hoang-Long DU, Clayton, Victoria (AU)

(21) Appl. No.: 18/567,599

(22) PCT Filed: May 25, 2022
(86) PCT No.: PCT/AU2022/050502

§ 371 Date: Dec. 6, 2023

(30) Foreign Application Priority Data
Jun. 10, 2021 (AU) 2021901749

(51) Int. Cl. C25B 1/27; C25B 1/50; C25B 9/17; C25B 9/19

(52) U.S. Cl. CPC C25B 1/27; C25B 1/50; C25B 9/17; C25B 9/19

(57) ABSTRACT

The invention provides a method of reducing dinitrogen to produce ammonia, the method comprising: contacting a cathode of an electrochemical cell with an electrolyte comprising: (i) a metal cation selected from the group consisting of lithium, magnesium, calcium, strontium, barium, zinc, aluminium, vanadium and combinations thereof, wherein the metal cation is present at a concentration of greater than 0.5 mol/L in the electrolyte, (ii) one or more anions comprising at least one negative ion selected from the group consisting of fluorinated sulfonyl imides, fluorinated sulfonyl methides and combinations thereof, (iii) a proton carrier; and (iv) optionally, at least one phosphonium cation, wherein the combined amount of the metal cation and the optional at least one phosphonium cation is greater than 1 mol/L in the electrolyte; supplying dinitrogen to the electrochemical cell for cathodic reduction; and applying a potential at the cathode sufficient to reduce the dinitrogen, thereby producing ammonia.

### TECHNICAL FIELD

The invention relates to a method of reducing dinitrogen to produce ammonia. The method comprises contacting a cathode of an electrochemical cell with an electrolyte comprising a high concentration of metal cation (e.g. lithium), at least one negative ion selected from the group consisting of fluorinated sulfonyl imides, fluorinated sulfonyl methides and combinations thereof, and a proton carrier, supplying dinitrogen to the electrochemical cell for cathodic reduction and applying a potential at the cathode sufficient to reduce the dinitrogen to form ammonia. The invention further relates to an electrochemical cell for reducing dinitrogen to produce ammonia.

### BACKGROUND OF INVENTION

Providing food and energy sufficient to meet the requirements of a burgeoning world population remains an ongoing challenge for humanity. New technologies for dinitrogen (N₂) fixation to form ammonia (NH₃) offer potential solutions to both of these challenges: synthetic ammonia-based fertilizers are already critical to global food production and the high energy density of NH₃ provides a significant prospect for its use as a transportable fuel or carrier of renewable energy.

The invention of the Haber-Bosch process in the 20th century provided for the first time an industrial route to produce large volumes of synthetic ammonia. However, due to the exceptional stability of the dinitrogen triple bond (N≡N, 942 kJ mol⁻¹), the Haber-Bosch process requires extreme reaction conditions of elevated pressure (150-350 atm) and temperature (400-550° C.), as well as a supply of pure H₂ which is typically sourced from the steam reforming process of natural gas. Consequently, the process consumes approximately 2% of global energy supply and contributes ˜1.5% of global greenhouse gas emissions. Technologies for N₂ conversion to NH₃ which can be powered by renewable resources are thus urgently needed.

The development of a successful electrochemical nitrogen reduction reaction (NRR) process would enable the direct conversion of renewable electricity into NH₃ in a simple electrolytic cell. The cathodic half-reaction of the NRR is shown in equation (1):

$${N}_{2} + 6 {H}^{+} + 6 {e}^{-} \to 2 {NH}_{3} \qquad ( 1 )$$

Instead of relying on steam reformed H₂, the protons required for NRR can be supplied by anodic oxidation of water (the oxygen evolution reaction) or H₂ generated from sustainable water-splitting processes. Unfortunately, the 6e⁻ and 6H⁺NRR is kinetically sluggish and thus electrochemically disadvantaged over the more facile 2e⁻ and 2H⁺ hydrogen evolution reaction (HER) shown in equation (2). As a result of competition from the HER, many reported electrochemical syntheses of NH₃ suffer from very low faradaic efficiency and/or low NH₃ yield rates.

$$2 {H}^{+} + 2 {e}^{-} \to {H}_{2} \qquad ( 2 )$$

One approach to address this issue is disclosed in DE102018210304, wherein suitable metals including lithium, magnesium, calcium, strontium, barium, zinc, aluminium, and vanadium are used to form the corresponding nitride. The metal in its metallic form is first formed, preferably in its liquid state by electrolysis of a metal ion containing molten salt at elevated temperatures, and then reacted with N₂ to form the metal nitride. Once formation of the nitride is complete, it is separated and introduced into the anode compartment of an electrochemical cell where protons are produced, ultimately producing ammonia. The need to manipulate the metal nitride compound between separate process environments creates a complex multistep process which is capital intensive in terms of equipment and energy inefficient.

Another approach previously developed, for example as reported by Tsuneto et al, Chemistry Letters 1993, 851-854, is the continuous lithium-mediated electrochemical ammonia synthesis. In a typical continuous Li-mediated electrochemical NH₃ synthesis reaction, the electrolyte system includes Li salts such as lithium triflate (LiOTf), lithium perchlorate (LiClO₄) or lithium tetrafluoroborate (LiBF₄) and a proton carrier (proton donor) in an organic solvent such as tetrahydrofuran. The proposed mechanism for this reaction is shown in FIG. 1, for the case where the source of protons is anodic H₂ oxidation. At cathode 102, lithium cations (Li⁺) are reduced to metallic lithium (Li), which spontaneously reacts with dinitrogen (N₂) to form lithium nitride (Li₃N). The Li₃N is then protonated by the proton carrier (BH) present in the electrolyte to produce ammonia and a deprotonated proton carrier (proton acceptor B), and regenerate the lithium cations. At anode 104, protons (H⁺) are produced by anodic oxidation of H₂; these protons protonate B in the electrolyte to regenerate the proton carrier (BH) and thus complete the reaction cycle. Since the protons are only indirectly involved in the nitrogen reduction reaction, it is expected that competition from the HER can be minimised.

Despite significant advances to date, the development of a commercially viable lithium-mediated NRR process requires further improvements in yield rate and selectivity (faradaic efficiency). Moreover, this performance must be sustainable over extended reaction times, e.g. multiple days of uninterrupted reaction. A significant challenge with the lithium-mediated NRR is the formation of insoluble by-products on the cathode. Deposition of these electrolyte decomposition materials can cause a rapid increase in the internal resistance of the cell, and thus the cell voltage required to drive the desired reaction, eventually leading to unstable and deteriorating electrochemical performance and premature termination of the reaction. Moreover, parasitic decomposition reactions consume a portion of the charge in the electrochemical process, resulting in lower faradaic efficiencies, and progressively and irreversibly destroy the solvent, electrolyte and/or proton carrier.

There is therefore an ongoing need for new methods of reducing dinitrogen to produce ammonia which at least partially address one or more of the above-mentioned short-comings, or provide a useful alternative.

A reference herein to a patent document or other matter which is given as prior art is not to be taken as an admission that the document or matter was known or that the information it contains was part of the common general knowledge as at the priority date of any of the claims.

### SUMMARY OF INVENTION

In accordance with a first aspect the invention provides a method of reducing dinitrogen to produce ammonia, the method comprising: contacting a cathode of an electrochemical cell with an electrolyte comprising: (i) a metal cation selected from the group consisting of lithium, magnesium, calcium, strontium, barium, zinc, aluminium, vanadium and combinations thereof, wherein the metal cation is present at a concentration of greater than 0.5 mol/L in the electrolyte, (ii) one or more anions comprising at least one negative ion selected from the group consisting of fluorinated sulfonyl imides, fluorinated sulfonyl methides and combinations thereof, (iii) a proton carrier; and (iv) optionally, at least one phosphonium cation, wherein the combined amount of the metal cation and the optional at least one phosphonium cation is greater than 1 mol/L in the electrolyte; supplying dinitrogen to the electrochemical cell for cathodic reduction; and applying a potential at the cathode sufficient to reduce the dinitrogen, thereby producing ammonia.

Surprisingly, it has been found that the use of fluorinated sulfonyl imide or methide anions in combination with a high concentration of suitable cations in the electrolyte provides very significant improvements in yield rate and/or faradaic efficiency in continuous metal-mediated electrochemical dinitrogen reduction, in comparison to electrolytes previously used in this process. The reduction performance is particularly remarkable at (a) metal cation concentrations above 1 mol/L, or (b) at metal concentrations above 0.5 mol/L when supplemented with a phosphonium cation such that the total metal+phosphonium concentration is above 1 mol/L. The metal cation (and the phosphonium cation when present) are typically the most abundant cations in the electrolyte, and it is preferred that interfering non-metal cations such as of imidazolium and pyrrolidinium cations are absent or present only in amounts sufficiently low that they do not unacceptably affect the dinitrogen reduction reaction. Further preferably, the fluorinated sulfonyl imide or methide anion is the main, or only, anion present in the electrolyte. Overall yield rates of up to 500 nmol s⁻¹ cm⁻² (normalised to the cathode surface area) and near-quantitative faradaic efficiencies (>98%) were thus obtained during reactions of 24 or 96 hour duration.

Without wishing to be limited by any theory, it is proposed that the metal cations and the bulky, electrochemically stable fluorinated sulfonyl imide or methide anions form a protective ionic assembly in an electrolyte-electrode interface layer at the cathode surface during electrochemical reduction. This protective interface, which is enhanced at high ionic concentrations, suppresses the decomposition of solution components (e.g. anions, solvent molecules or proton carrier) and excessive deposition of products of reduction processes involving the metal mediator (e.g. metallic metal, metal nitride or metal hydride), while still permitting high rates of dinitrogen reduction. As a result, highly productive and selective reduction of dinitrogen to ammonia can be obtained and sustained for long reaction times.

The protective effect provided by the electrolyte composition disclosed herein can be discerned by analysis of the cathode surface after the electrochemical reaction. After extended reaction in electrolytes containing high concentrations of lithium bis(trifluoromethanesulfonyl)imide (LiTFSI), the cathode surface was visually pristine. Microscopy and spectroscopic analysis indicated the presence of a thin (<10 nm) but coherent solid layer of LiF, S—O species and intact LiTFSI. By contrast, the use of other weakly coordinating anions or low lithium concentrations in the electrolyte resulted in substantial amounts of insoluble products deposited on the cathode.

Fluorinated sulfonyl imide and methide anions have previously been used in lithium-based electrolytes for secondary batteries, where they promote cycling stability via the formation of a stable solid-electrolyte interface (SEI) layer at the electrodes. The inventors have recognised an analogy between the electrolyte-electrode interfaces present during lithium battery cycling and lithium-mediated dinitrogen reduction reaction. A range of fluorinated sulfonyl imide and methide anions suited to lithium battery applications may thus be used in the methods of the present disclosure.

In accordance with a second aspect the invention provides a method of reducing dinitrogen to produce ammonia, the method comprising: contacting a cathode of an electrochemical cell with an electrolyte comprising: (i) a metal cation selected from the group consisting of lithium, magnesium, calcium, strontium, barium, zinc, aluminium, vanadium and combinations thereof, wherein the metal cation is present at a concentration of greater than 1 mol/L in the electrolyte, (ii) one or more anions comprising at least one negative ion selected from the group consisting of fluorinated sulfonyl imides, fluorinated sulfonyl methides and combinations thereof, and (iii) a proton carrier; supplying dinitrogen to the electrochemical cell for cathodic reduction; and applying a potential at the cathode sufficient to reduce the dinitrogen, thereby producing ammonia.

In accordance with a third aspect the invention provides an electrochemical cell for reducing dinitrogen to produce ammonia, the electrochemical cell comprising: a cathode; an anode; an electrolyte in contact with at least the cathode, the electrolyte comprising: i) a metal cation selected from the group consisting of lithium, magnesium, calcium, strontium, barium, zinc, aluminium, vanadium and combinations thereof, wherein the metal cation is present at a concentration of greater than 0.5 mol/L in the electrolyte, (ii) one or more anions comprising at least one negative ion selected from the group consisting of fluorinated sulfonyl imides, fluorinated sulfonyl methides and combinations thereof, (iii) a proton carrier; and (iv) optionally, at least one phosphonium cation, wherein the combined amount of the metal cation and the optional at least one phosphonium cation is greater than 1 mol/L in the electrolyte; a source of dinitrogen to supply dinitrogen to the electrochemical cell for cathodic reduction; and a power supply connected to the cathode and the anode, the power supply capable of applying a potential at the cathode sufficient to reduce the dinitrogen, thereby producing ammonia.

In accordance with a fourth aspect the invention provides an electrochemical cell for reducing dinitrogen to produce ammonia, the electrochemical cell comprising: a cathode; an anode; an electrolyte in contact with at least the cathode, the electrolyte comprising: i) a metal cation selected from the group consisting of lithium, magnesium, calcium, strontium, barium, zinc, aluminium, vanadium and combinations thereof, wherein the metal cation is present at a concentration of greater than 1 mol/L in the electrolyte, (ii) one or more anions comprising at least one negative ion selected from the group consisting of fluorinated sulfonyl imides, fluorinated sulfonyl methides and combinations thereof, and (iii) a proton carrier; a source of dinitrogen to supply dinitrogen to the electrochemical cell for cathodic reduction; and a power supply connected to the cathode and the anode, the power supply capable of applying a potential at the cathode sufficient to reduce the dinitrogen, thereby producing ammonia.

In some embodiments of the first and third aspects, the metal cation is present at a concentration of greater than 0.75 mol/L, or greater than 1 mol/L, in the electrolyte.

In some embodiments of the first and third aspects, the combined amount of the metal cation and the optional at least one phosphonium cation is greater than 1.5 mol/L in the electrolyte.

In some embodiments of the first to fourth aspects, the metal cation is present at a concentration of greater than 1.25 mol/L, or greater than 1.5 mol/L, or greater than 1.75 M, in the electrolyte.

In some embodiments of the first to fourth aspects, the at least one negative ion is selected from the group consisting of fluorinated sulfonyl imides.

In some embodiments of the first to fourth aspects, the fluorinated sulfonyl imides have a structure according to Formula 1:

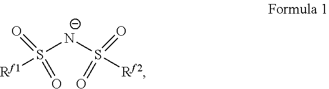

wherein R^{f1} and R^{f2} are independently selected from the group consisting of —F, C₁-C₁₂ perfluoroalkyl and fluoroaryl, or wherein R^{f1} and R^{f2} are connected to form a perfluoroalkylene linker. In some such embodiments, R^{f1} and R^{f2} are independently selected from the group consisting of —F and C₁-C₆ perfluoroalkyl.

In some embodiments of the first to fourth aspects, the at least one negative ion is selected from the group consisting of bis(trifluoromethanesulfonyl)imide (TFSI), bis(fluorosulfonyl)imide (FSI), (trifluoromethanesulfonyl)-(fluorosulfonyl)-imide (FTFSI), tris(trifluoromethanesulfonyl) methide, and combinations thereof. In some embodiments, the at least one negative ion consists of TFSI.

In some embodiments of the first to fourth aspects, the at least one negative ion is present at a concentration of greater than 1 mol/L, or greater than 1.25 mol/L, or greater than 1.5 mol/L, in the electrolyte.

In some embodiments of the first and third aspects, the at least one negative ion is present at a concentration substantially equal to or greater than the combined amount of the metal cation and the optional at least one phosphonium cation.

In some embodiments of the first to fourth aspects, the at least one negative ion comprises at least 50 mol %, or at least 80 mol %, or at least 90 mol %, of the one or more anions.

In some embodiments of the first to fourth aspects, the at least one negative ion comprises at least 90 mol %, or substantially 100 mol %, of a total amount of weakly coordinating anion in the electrolyte.

In some embodiments of the first to fourth aspects, the metal cation is lithium.

In some embodiments of the first to fourth aspects, the electrolyte comprises at least one phosphonium cation. The at least one phosphonium cation may be present at a concentration of greater than 0.2 mol/L, or greater than 0.4 mol/L, for example between 0.2 mol/L and 1.5 mol/L, such as between 0.4 mol/L and 1.2 mol/L, in the electrolyte.

In some embodiments of the first to fourth aspects, the electrolyte is substantially free of organonitrogen cations or comprises any organonitrogen cations in a combined amount of less than 0.2 mol/L, such as less than 0.1 mol/L.

In some embodiments of the first to fourth aspects, the cathode comprises a metal selected from the group consisting of Ni, Nb, Ti, Mo, Fe, Cu, Ag, Zn and alloys thereof. In some such embodiments, the cathode comprises metallic nickel or niobium.

In some embodiments of the first to fourth aspects, a metallic surface of the cathode is uncoated or is coated with a solid interfacial layer comprising LiF after producing ammonia for 6 hours, wherein the solid interfacial layer has a thickness of no more than 100 nm, or no more than 50 nm, or no more than 10 nm.

In some embodiments of the first and second aspects, producing ammonia comprises deprotonating the proton carrier to form a proton acceptor, and the method further comprises regenerating the proton carrier in the electrolyte by protonating the proton acceptor with protons introduced to the electrolyte by anodic oxidation of a hydrogen-containing species in the electrochemical cell. The hydrogen-containing species may optionally be dihydrogen or water.

In some embodiments of the first and second aspects, the proton carrier and the proton acceptor (formed by deprotonating the proton carrier) are present in the electrolyte in a combined concentration of greater than 0.001 mol/L, or greater than 0.01 mol/L, or in the range of between 0.05 mol/L and 0.5 mol/L. In some embodiments of the second aspect, the proton carrier and any proton acceptor formed by deprotonating the proton carrier are present in the electrolyte in a combined concentration of greater than 0.001 mol/L, or greater than 0.01 mol/L, or in the range of between 0.05 mol/L and 0.5 mol/L.

In some embodiments of the first and second aspects, producing ammonia comprises reducing the metal cation and the dinitrogen at the cathode to form a metal nitride; and reacting the metal nitride with the proton carrier to produce the ammonia.

In some embodiments of the first to fourth aspects, the proton carrier is selected from the group consisting of (a) a neutral proton carrier capable of reversible deprotonation to form an anionic proton acceptor, and (b) a cationic proton carrier capable of reversible deprotonation to form a neutral proton acceptor, wherein the neutral proton acceptor is an ylide.

In some such embodiments, the proton carrier is (a) the neutral proton carrier, and the neutral proton carrier is selected from the group consisting of an alcohol and an acid. In some embodiments, the neutral proton carrier is an alcohol, optionally selected from the group consisting of methanol, ethanol, a propanol and a butanol.

In other embodiments, the proton carrier is (b) the cationic proton carrier. In some such embodiments, the cationic proton carrier is selected from the group consisting of an alkyl phosphonium cation and an alkyl sulfonium cation, and the neutral proton acceptor is selected from the group consisting of a phosphonium ylide and a sulfonium ylide. The cationic proton carrier may be a tetra-alkyl phosphonium cation, optionally of the form [PR⁶R⁷R⁸R⁹]⁺ wherein R⁶, R⁷, R⁸ and R⁹ are independently selected from C₁-C₂₀ n-alkyl.

In some embodiments of the first to fourth aspects, the electrolyte further comprises (iv) one or more molecular solvents selected from the group consisting of ethers, polyethers, glycol ethers, fluorinated ethers, fluorinated alkyls, fluorinated cycloalkyls, carbonates, sulfolane and dimethylsulfoxide.

In some embodiments of the first to fourth aspects, the electrolyte comprises an aprotic donor solvent capable of solvating the metal cations.

In some embodiments of the first and second aspects, the dinitrogen is supplied to the electrochemical cell for cathodic reduction by contacting the electrolyte with dinitrogen at a dinitrogen partial pressure of greater than 1 bar, or greater than 5 bar, or greater than 10 bar. In some embodiments of the third and fourth aspects, the source of dinitrogen supplies dinitrogen to the electrochemical cell for cathodic reduction by contacting the electrolyte with dinitrogen at a dinitrogen partial pressure of greater than 1 bar, or greater than 5 bar, or greater than 10 bar.

In some embodiments of the first and second aspects, the cathode is not contacted with gaseous dinitrogen at a static gas-electrolyte meniscus when producing the ammonia. In some embodiments of the third and fourth aspects, the electrochemical cell is configured so that the cathode is not contacted with gaseous dinitrogen at a static gas-electrolyte meniscus when producing the ammonia.

In some embodiments of the first and second aspects, the potential at the cathode is below (more negative than) an apparent reduction potential of the metal cation in the electrolyte, and preferably below (more negative than) −0.4 V relative to the apparent reduction potential of the metal cation in the electrolyte.

In some embodiments of the first and second aspects, the potential at the cathode is above (more positive than) −0.8 V relative to an apparent reduction potential of the metal cation in the electrolyte.

In some embodiments of the first to fourth aspects, the electrolyte has a viscosity of less than 20 MPa s at 25° C.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 schematically depicts the proposed mechanism of the continuous electrochemical dinitrogen reduction to produce ammonia.

FIG. 2 schematically depicts a single compartment electrochemical cell for performing a continuous electrochemical dinitrogen reduction according to embodiments of the invention, using H₂ as the hydrogen-containing species.

FIG. 3 schematically depicts a membrane-separated dual compartment electrochemical cell for performing a continuous electrochemical dinitrogen reduction according to embodiments of the invention, using H₂O as the hydrogen-containing species.

FIG. 4 depicts (a) the ionic conductivity and viscosity of electrolytes containing different concentrations of LiTFSI (0.1 mol/L to 3 mol/L) and ethanol (EtOH) (0.1 mol/L) in tetrahydrofuran (THF), and (b) the ammonia yield rate and faradaic efficiency obtained in a series of chronoamperometric electrochemical experiments with these electrolytes, conducted under 15 bar N₂ pressure at −0.55 V vs Li/Li⁺ on a nickel cathode in Example 1.

FIG. 5 plots the ammonia yield rate (diamonds) and faradaic efficiency (triangles) obtained in a series of chronoamperometric electrochemical experiments with electrolytes containing different lithium salts (1 mol/L or 2 mol/L) and EtOH (0.1 mol/L) in THF, conducted under 15 bar N₂ pressure at −0.55 V vs Li/Li⁺ on a nickel cathode in Example 2. The results are plotted relative to (a) the electrolyte viscosity and (b) the electrolyte ionic conductivity.

FIG. 6 is an X-ray photoelectron (XP) spectrum (S 2p region) showing the sulfur species present on the cathode surface after a chronoamperometric electrochemical experiment with electrolyte containing LiTFSI (2 mol/L) and EtOH (0.1 mol/L) in THF, conducted under 15 bar N₂ pressure at −0.55 V vs Li/Li⁺ on a nickel cathode in Example 1. NRR-region B is the portion of the cathode fully submerged in the electrolyte. NRR-region A is the portion of the cathode where electrochemical reactions occurred at a static gas-electrolyte meniscus.

FIG. 7 is an XP spectrum (N 1s region) showing the nitrogen species present on the cathode surface after a chronoamperometric electrochemical experiment with electrolyte containing LiTFSI (2 mol/L) and EtOH (0.1 mol/L) in THF, conducted under 15 bar N₂ pressure at −0.55 V vs Li/Li⁺ on a nickel cathode in Example 1.

FIG. 8 is an XP spectrum (F 1s region) showing the fluorine species present on the cathode surface after a chronoamperometric electrochemical experiment with electrolyte containing LiTFSI (2 mol/L) and EtOH (0.1 mol/L) in THF, conducted under 15 bar N₂ pressure at −0.55 V vs Li/Li⁺ on a nickel cathode in Example 1.

FIG. 9 is an XP spectrum (Ni 2p region) showing the nickel species present on the cathode surface after a chronoamperometric electrochemical experiment with electrolyte containing LiTFSI (2 mol/L) and EtOH (0.1 mol/L) in THF, conducted under 15 bar N₂ pressure at −0.55 V vs Li/Li⁺ on a nickel cathode in Example 1.

FIG. 10 plots the current density, total charge passed and overall cell potential as a function of time for a series of chronoamperometric electrochemical experiments with electrolytes containing LiTFSI (2 mol/L) and EtOH (0.1 mol/L) in THF, conducted under 15 bar N₂ pressure at −0.55 V vs Li/Li⁺ on an isolated nickel cathode in Example 5.

FIG. 11 depicts the current density as a function of time for a series of chronoamperometric electrochemical experiments with electrolytes containing LiTFSI (2 mol/L) and EtOH (0.1 mol/L) in THF, conducted under 15 bar N₂ pressure at a range of different cathode potentials (−0.4 V to −1 V vs Li/Li⁺) on a nickel cathode in Example 6.

FIG. 12 shows a series of ³¹P NMR spectra obtained in Example 9, demonstrating the reversible deprotonation of the [P_{666,14}]⁺ cation in a 0.2 M solution of [P_{666,14}][eFAP] in THF, by sequential deprotonation with lithium nitride and re-protonation reaction by a weak acid.

FIG. 13 plots (a) the ammonia yield rate and (b) the faradaic efficiency obtained in a series of chronoamperometric electrochemical experiments with electrolytes containing LiTFSI (2 mol/L) and different types and concentrations of proton carriers, as a function of proton carrier concentration, conducted under 15 bar N₂ pressure at −0.55 V vs Li/Li⁺ on a nickel cathode in Example 8.

FIG. 14 plots the ammonia yield rate (diamonds) and the faradaic efficiency (bars) obtained in a series of chronoamperometric electrochemical experiments with electrolytes containing LiTFSI (2 mol/L) and different alcohol proton carriers (0.1 M), conducted under 15 bar N₂ pressure at −0.55 V vs Li/Li⁺ on a nickel cathode in Example 8.

FIG. 15 plots the ammonia yield rate (diamonds) and the faradaic efficiency (bars) obtained in a series of chronoamperometric electrochemical experiments with electrolytes containing LiTFSI (2 mol/L) and EtOH (0.1 M), conducted under 15 bar total pressure with varying N₂ and H₂ partial pressures at −0.55 V vs Li/Li⁺ on a nickel cathode in Example 10.

FIG. 16 plots the ammonia yield rate (diamonds) and the faradaic efficiency (bars) obtained in a series of chronoamperometric electrochemical experiments with electrolytes containing LiTFSI (1-2 mol/L), EtOH (0.1 M) and various ionic liquid additives, conducted under 15 bar N₂ pressure on a nickel cathode in Example 11.

FIG. 17 plots the ammonia yield rate (diamonds) and the faradaic efficiency (bars) obtained in a series of chronoamperometric electrochemical experiments with electrolytes containing LiTFSI (1.5-2 mol/L), EtOH (0.1 M) and different amounts of a phosphonium-based ionic liquid additive, conducted at 1 bar N₂ pressure on a nickel cathode in Example 12.

FIG. 18 depicts the current density as a function of time for a series of chronoamperometric electrochemical experiments with electrolytes containing LiTFSI (0.2-1.5 mol/L), EtOH (0.1 M) and different amounts of a phosphonium-based ionic liquid additive, conducted at 15 bar N₂ pressure on a nickel cathode in Example 13.

FIG. 19 plots the ammonia yield rate (diamonds) and the faradaic efficiency (bars) obtained in a series of chronoamperometric electrochemical experiments with electrolytes containing LiTFSI (0.2-1.5 mol/L), EtOH (0.1 M) and different amounts of a phosphonium-based ionic liquid additive, conducted at 15 bar N₂ pressure on a nickel cathode in Example 13.

### DETAILED DESCRIPTION

### Method of Reducing Dinitrogen to Produce Ammonia

The present invention relates to a method of reducing dinitrogen to produce ammonia. The method comprises contacting a cathode of an electrochemical cell with an electrolyte comprising: (i) a metal cation selected from the group consisting of lithium, magnesium, calcium, strontium, barium, zinc, aluminium, vanadium and combinations thereof, at a concentration of greater than 0.5 mol/L in the electrolyte, (ii) one or more anions comprising at least one negative ion selected from the group consisting of fluorinated sulfonyl imides, fluorinated sulfonyl methides and combinations thereof, (iii) a proton carrier and (iv) optionally, at least one phosphonium cation. The combined amount of the metal cation and the optional phosphonium cation component is greater than 1 mol/L in the electrolyte. Thus, for the case where phosphonium cation is absent, the metal cation is present at a concentration of greater than 1 mol/L in the electrolyte. Dinitrogen is supplied to the electrochemical cell for cathodic reduction, and a potential is applied at the cathode which is sufficiently negative to reduce the dinitrogen, thereby producing ammonia. The proton carrier provides the protons for producing the ammonia, and may thus be deprotonated to form a proton acceptor.

In general, the electrochemical cell also includes an anode where an anodic oxidation reaction occurs during the electrochemical ammonia synthesis to maintain charge neutrality and allow a flow of current through the cell. Anodic oxidation of a hydrogen-containing species, such as dihydrogen or water, at the anode introduces protons to the electrolyte. These protons may at least partially regenerate the proton carrier in the electrolyte by re-protonating the proton acceptor.

The present disclosure thus relates to a continuous metal-mediated (e.g. lithium-mediated) electrochemical dinitrogen reduction process. Such a process can be distinguished from a sequential electrochemical process where dinitrogen is converted to ammonia in a series of temporally and/or spatially separated process steps, e.g. separate batch processes for lithium electrolysis, lithium nitride formation and ammonia production. As explained above, it is proposed that the continuous reduction involves cycling of one or more species, including a metal species and/or the proton carrier species, between different forms in a single process step of the synthesis.

### Metal and Optional Phosphonium Cations

The electrolyte comprises at least one metal cation to mediate, or catalyse, the continuous electrochemical dinitrogen reduction. It is proposed that the synthesis involves a metal nitride intermediate in the reaction cycle. Accordingly, a range of metals capable of forming metal nitrides from dinitrogen under the electrochemical reaction conditions may be used in the invention. As used herein, a “metal” refers to a metal element, and does not imply a specific reduction state or species. Where a metal in its zero oxidation state metallic form is specifically identified, for example in the context of a proposed reaction mechanism, this will be termed its “metallic form”, “metallic metal” or “metal(0)”.

According to the proposed mechanism, electrochemical reduction of metal cations produces metallic metal on the cathode, which spontaneously reacts with N₂ to produce the corresponding metal nitride. This latter reaction should thus be thermodynamically favourable (negative Gibbs energy of the generic reaction nM⁺+mN₂⇄MₙN₂ₘ) under the conditions of the ammonia electrosynthesis. Based on tabulated thermodynamic data (e.g. L. B. Pankratz, et al, Thermodynamic Data for Mineral Technology, Washington D.C., 1984 John R. Rumble, CRC Handbook of Chemistry and Physics 101st Edition, 2020), published theoretical calculations (e.g. Nørskov et al, in Energy Environ. Sci., 2017, 10, 1621-1630) and experimental reports (e.g. DE102018210304), suitable metals include lithium, magnesium, calcium, strontium, barium, zinc, aluminium, and vanadium.

In some embodiments, the metal comprises, or consists of, lithium. Lithium is considered particularly suitable due to its demonstrated ability to activate dinitrogen at ambient temperatures.

It is expected that the metal may remain present during ongoing reduction primarily in the form of metal cations dissolved in the electrolyte, e.g. Lit. As noted above, it is believed that the reaction cycle involves a reduction of metal cations, from the electrolyte, to form metallic metal on the cathode, with the metal cations being regenerated as the final step of the cycle. However, it is also considered possible that the metal cycles during continuous reaction between solid species on the cathode surface (for example metal nitride and metallic metal) without soluble metal cations as an intermediate. Thus, for the case of lithium, the cathodic reaction mechanism might in principle involve (i) chemical reaction of metallic lithium on the cathode with dinitrogen to form lithium nitride, and (ii) direct electrochemical reduction of the lithium nitride in the presence of the proton donor to directly regenerate metallic lithium and produce ammonia (i.e. Li₃N+3HB+3e⁻=NH₃+3Li(0)+3B⁻).

The metal cation(s) are present in the electrolyte in a concentration of greater than 0.5 mol/L. In some preferred embodiments, the metal cation(s) are present at a concentration of greater than 0.75 mol/L, or greater than 1 mol/L, or greater than 1.5 mol/L, in the electrolyte. It should be appreciated that metal cation concentrations in such ranges imply that the electrolyte contains a very high mass fraction of metal salt. For example, 1.5 mol/L of LiTFSI corresponds to 430 g/L, or above 37 mass %. It has surprisingly been found that such high concentrations of metal cations in the metal-mediated NRR provide improved electrochemical performance (faradaic efficiency and/or yield rate) and suppress the formation of electrolyte decomposition products on the cathode. Without wishing to be limited by any theory, it is proposed that high ionic concentrations enhance the protective ionic assembly of metal cations and fluorinated sulfonyl imides or methides at the cathode surface. The upper range of the metal cation concentration may be limited by the viscosity of the electrolyte, which may restrict mass transfer and ionic conductivity at high concentrations of electrolyte salts. Such limitations may depend on factors such as the presence and choice of any solvent and the reaction temperature. In some embodiments, the metal cation(s) are thus present at a concentration of less than 3 mol/L, for example in the range of 1 mol/L to 3 mol/L, such as 1.5 mol/L to 2.5 mol/L. As used herein, “mol/L” and “M” are used interchangeably as units of molar concentration (moles per litre).

The metal is most conveniently introduced to the electrochemical cell in cationic form, for example by dissolving a suitable metal salt in the electrolyte. However, it is not excluded that the metal is introduced as metal nitride or even in the metallic form. Metal cations may be generated in situ in the electrolyte from such species.

The metal cations, such as lithium cations, may be the most abundant (i.e. greater than 50% of total cations present), or the only cationic species present in significant concentrations in the electrolyte during ammonia synthesis. In some embodiments, the electrolyte is thus substantially free of non-metal cations or comprises any non-metal cations in a combined amount of less than 0.2 mol/L, such as less than 0.1 mol/L.

However, other cations may be present in some embodiments, provided that they do not unacceptably affect the electrochemical performance. In particular, a phosphonium cation has been found to be a suitable complement to the metal cation, in some cases increasing the faradaic efficiency of the dinitrogen reduction reaction. Thus, in some embodiments, the electrolyte comprises at least one phosphonium cation, sufficient such that the combined amount of the metal and phosphonium cations is greater than 1 mol/L in the electrolyte. In some embodiments, the phosphonium cation is present in an amount of greater than 0.2 mol/L (for example between 0.2 mol/L and 1.5 mol/L), or greater than 0.4 mol/L (for example between 0.4 mol/L and 1.2 mol/L), in the electrolyte.

However, it has been found by experiment that certain other non-metal cations, such as imidazolium and pyrrolidinium cations, adversely affect the faradaic efficiency and/or yield rate of the metal-mediated NRR. Accordingly, in some embodiments, the electrolyte is substantially free of imidazolium and pyrrolidinium cations, or comprises any imidazolium and pyrrolidinium cations in a combined amount of less than 0.5 mol/L, or less than 0.2 mol/L, such as less than 0.1 mol/L. In some embodiments, the electrolyte is substantially free of organonitrogen cations, or comprises any organonitrogen cations in a combined amount of less than 0.5 mol/L, or less than 0.2 mol/L, such as less than 0.1 mol/L. As used herein, an organonitrogen cation refers to an organic cation containing a cationic nitrogen centre, including imidazolium, pyrrolidinium, ammonium and the like. In some embodiments, the electrolyte is substantially free of non-metal cations other than phosphonium, or comprises any non-metal cations other than phosphonium in a combined amount of less than 0.5 mol/L, or less than 0.2 mol/L, such as less than 0.1 mol/L.

The phosphonium cation (when present) may suitably be an alkyl phosphonium cation, such as a tetraalkylphosphonium cation. The tetra-alkyl phosphonium cation may have the structure [PR⁶R⁷R⁸R⁹]⁺, wherein R⁶, R⁷, R⁸ and R⁹ are independently selected from C₁-C₂₀ n-alkyl. In some embodiments, the combined sum of the carbon atoms in R⁶, R⁷, R⁸ and R⁹ is at least 7, or at least 13, or at least 16. As the skilled person will appreciate, an increase in the combined chain length of the tetra-alkyl phosphonium cation will generally increase its solubility in organic media, reduce the melting point of its salts and decrease its tendency to absorb or dissolve water. In some embodiments, R⁶, R⁷ and R⁸ are independently selected from C₄-C₂₀ n-alkyl and R⁹ is a C₁-C₂₀ n-alkyl.

In some embodiments, the alkyl phosphonium cation is an ionic liquid cation, meaning that it is capable of forming an ionic liquid, for example a room temperature ionic liquid, when paired with a suitable counterion (for example the at least one negative ion selected from the group consisting of fluorinated sulfonyl imides, fluorinated sulfonyl methides and combinations thereof). As used herein, an ionic liquid is a salt with a melting temperature of below 100° C., while a room temperature ionic liquid has a melting temperature below 25° C. Such cations may be preferred due to their high solubility/miscibility with other solvents and salts in the electrolyte, their high conductivity and their capability (in an ionic liquid) to dissolve a high concentration of N₂.

### Anions

The electrolyte comprises one or more anions including at least one negative ion selected from the group consisting of fluorinated sulfonyl imides, fluorinated sulfonyl methides and combinations thereof. The anion(s) are present to charge balance the cationic species present in the electrolyte, including the metal cations and any other cationic species present. As used herein, the terms anion and negative ion have the same meaning.

The anions, and in particular the anions intentionally formulated into the electrolyte prior to commencement of electrochemical reaction, are preferably weakly coordinating anions. A wide range of weakly coordinating anions, sometimes referred to as non-coordinating anions, are known in the fields of electrochemical synthesis and ionic liquid technology. Non-limiting examples of weakly coordinating anions include tetrafluoroborate, hexafluorophosphate, perchlorate, fluoroalkyl phosphates such as tris(pentafluoroethyl)trifluorophosphate, fluoroaryl borates such as tetrakis [3,5-bis(trifluoromethyl)phenyl] borate and tetrakis(pentafluorophenyl) borate, fluoroalkyl borates such as tetrakis [hexafluoroisopropyl]borate, fluorinated sulfonates such as trifluoromethanesulfonate (triflate) and other perfluoroalkylsulfonates (e.g. perfluorohexanesulfonate), fluorinated sulfonyl imides such as bis(fluorosulfonyl)imide, bis(trifluoromethanesulfonyl)imide and (fluorosulfonyl)-(trifluoromethanesulfonyl)imide, and fluorinated sulfonyl methides such as tris(trifluoromethanesulfonyl) methide.

While weakly coordinating anions are preferred for electrochemical applications, it is not excluded that other anions may be present in the electrolyte in combination with the fluorinated sulfonyl imides or methide negative ion(s). For example, chloride is considered sufficiently stable against anodic oxidation in some embodiments, for example when the anode reaction is H₂ oxidation, and may thus be used.

The anion(s) present in the electrolyte include at least one negative ion selected from the group consisting of fluorinated sulfonyl imides, fluorinated sulfonyl methides and combinations thereof. As used herein, a fluorinated sulfonyl imide is a singly charged anion comprising a negative nitrogen atom covalently bonded to one or two fluorinated sulfonyl groups (i.e. —SO₂—R^{f}, where R^{f} is a fluorine-substituted organyl group). As used herein, a fluorinated sulfonyl methide is a singly charged anion comprising a negative carbon atom covalently bonded to one, two or three fluorinated sulfonyl groups (i.e. —SO₂—R^{f}, where R^{f} is a fluorine-substituted organyl group).

Fluorinated sulfonyl imides and methides are weakly coordinating anions with good electrochemical stability, attributable to the high degree of charge delocalisation from the formally negative nitrogen or carbon into the electron withdrawing fluorinated sulfonyl group(s). At least some fluorinated sulfonyl imides and methides are also sterically bulky anions. Fluorinated sulfonyl imide and methide anions have previously been used in lithium-based electrolytes for secondary batteries, where they can promote cycling stability via the formation of a stable solid-electrolyte interface (SEI) layer at the electrodes. Thus, for example, their use in electrolytes for lithium metal batteries can suppress lithium dendrite formation and electrolyte decomposition on the lithium-metal anode during battery charging. The inventors have recognised an analogy between such battery processes and the cathodic lithium-mediated electrochemical nitrogen reduction reaction. Accordingly, a range of fluorinated sulfonyl imide and methide anions previously demonstrated or proposed for lithium battery applications are suitable in the methods of the present disclosure. It is noted that nomenclature of these structures is non-systematic in the literature and the IUPAC nomenclature rules are not clear. For example, the anion [CF₃SO₂—N—SO₂CF₃]⁻ has been referred to both as an imide or an amide; here we use the term imide to describe the negatively charged nitrogen.

In some embodiments, the fluorinated sulfonyl imides have a structure according to Formula 2:

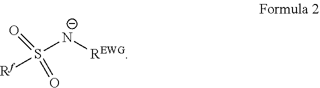

In Formula 2, R^{f} is a fluorinated organyl group, optionally selected from the group consisting of —F, fluoroalkyl (e.g. perfluoroalkyl) and fluoroaryl (e.g. perfluoroaryl). R^{EWG} is an electron withdrawing group, optionally selected from the group consisting of sulfonyl (e.g. fluorinated sulfonyl, —SO₂—R^{f}), cyano (—CN), and acyl groups (e.g. fluorinated acyl, —C(═O)—R^{f}), and nitroso (—N═O). Optionally, R^{f} and R^{EWG} are connected to form a cyclic structure.

Exemplary compounds according to Formula 2 which have been demonstrated or proposed for lithium battery applications include (i) methylcarbonate(trifluoromethanesulfonyl)imide (R^{f}═—CF₃; R^{EWG}=—C(═O)—CH₃) (Gunderson-Briggs et al, Angew. Chem. Int. Ed. 2019, 58, 4390), (ii) cyano (trifluoromethanesulfonyl)imide and cyano (perfluorobutanesulfonyl)imide (R^{f} ═—CF₃, —C₄F₉; R^{EWG}═—CN) (U.S. Pat. No. 6,294,289), (iii) bis(trifluoromethanesulfonyl)imide (TFSI), bis(fluorosulfonyl)imide (FSI), and (trifluoromethanesulfonyl)-(fluorosulfonyl)imide (FTFSI) (R^{f}═—CF₃, —F; R^{EWG}═—SO₂—CF₃, —SO₂—F), (iv) symmetrical and unsymmetrical bis(sulfonyl)imide salts containing various fluoroaryl groups (R^{f}═—CF₃, Ar^{f}; R^{EWG}—SO₂—Ar^{f}, where Ar^{f}=partially fluorinated aryl or perfluoroaryl groups) (Huang et al, Energy Environ. Sci., 2018, 11, 1326), and (v) cyclo-difluoromethane-1,1-bis(sulfonyl)imide (R^{f} connected to R^{EWG} to form —CF₂—) (Murmann et al, Phys. Chem. Chem. Phys., 2015, 17, 9352.

In some embodiments, the fluorinated sulfonyl methides have a structure according to Formula 3:

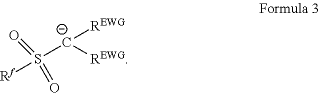

In Formula 3, R^{f} is a fluorinated organyl group, optionally selected from the group consisting of —F, fluoroalkyl (e.g. perfluoroalkyl) and fluoroaryl (e.g. perfluoroaryl). Each R^{EWG} is independently an electron withdrawing group, optionally selected from the group consisting of sulfonyl (e.g. fluorinated sulfonyl, —SO₂—R^{f}), cyano (—CN), and acyl groups (e.g. fluorinated acyl, —C(═O)—R^{f}), and nitroso (—N═O). Optionally, R^{f} and a R^{EWG} are connected to form a cyclic structure.

Exemplary compounds according to Formula 3 which have been demonstrated or proposed for lithium battery applications include (i) bis(cyano) (trifluoromethanesulfonyl) methide and bis(cyano) (perfluorobutanesulfonyl) methide (R^{f}═—CF₃, —C₄F₉; R^{EWG}═—CN) (U.S. Pat. No. 6,294,289), and (ii) tris(trifluoromethanesulfonyl) methide (R^{f}═—CF₃; R^{EWG}═—SO₂—CF₃), (Walker et al, J. Electrochem. Soc., Vol. 143, 1996).

In some embodiments, the at least one negative ion is selected from the group consisting of fluorinated sulfonyl imides, optionally having a structure according to Formula 2. In some embodiments, the fluorinated sulfonyl imide(s) have a structure according to Formula 1:

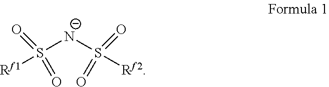

In Formula 1, R^{f1} and R^{f2} are independently selected from the group consisting of —F, C₁-C₁₂ perfluoroalkyl and fluoroaryl (optionally perfluoroaryl), or R^{f1} and R^{f2} are connected to form a perfluoroalkylene linker. In some embodiments, R^{f1} and R^{f2} are independently selected from the group consisting of F and C₁-C₆ perfluoroalkyl. In some embodiments, the at least one negative ion is selected from the group consisting of bis(trifluoromethanesulfonyl)imide (TFSI), bis(fluorosulfonyl)imide (FSI), (trifluoromethanesulfonyl) (fluorosulfonyl)imide (FTFSI), and combinations thereof. In some embodiments, the at least one negative ion consists of a single fluorinated sulfonyl imide as described herein. In some such embodiments, the at least one negative ion is TFSI (alternatively referred to as NTf₂).

The negative ion(s) selected from fluorinated sulfonyl imides, fluorinated sulfonyl methides and combinations thereof may be present at a concentration of greater than 1 mol/L, preferably greater than 1.25 mol/L, more preferably greater than 1.5 mol/L, in the electrolyte. In some embodiments, the concentration is substantially the same as the metal cation concentration. This may be the case if the electrolyte is formulated using only salt(s) of the metal cation and fluorinated sulfonyl imides and/or fluorinated sulfonyl methide anion(s). When the electrolyte comprises phosphonium cation(s), the concentration may be substantially the same as the combined concentration of the metal cation and phosphonium cation(s). This may be the case if the electrolyte is formulated using (i) salt(s) of the metal cation and fluorinated sulfonyl imide and/or fluorinated sulfonyl methide anion(s) in combination with (ii) salt(s) of the phosphonium cation(s) and fluorinated sulfonyl imide and/or fluorinated sulfonyl methide anion(s).

The negative ion(s) selected from fluorinated sulfonyl imides, fluorinated sulfonyl methides and combinations thereof are preferably the most abundant (i.e. greater than 50%), or only, weakly coordinating anion(s) present in the electrolyte. In some embodiments, the negative ion(s) comprise at least 50 mol %, or at least 80 mol %, or at least 90 mol %, or substantially 100 mol %, of the total amount of weakly coordinating anion present in the electrolyte. Without wishing to be limited by any theory, it is proposed that the minimisation or exclusion of other anions enhances the protective ionic assembly of metal cations and fluorinated sulfonyl imide (or methide) anions at the cathode surface.

In some embodiments, the negative ions are the most abundant (i.e. greater than 50%) anions in the electrolyte, or the only anions apart from any anionic reaction intermediates (such as deprotonated proton carriers) present in the electrolyte. In some embodiments, the at least one negative ion comprises at least 50 mol %, or at least 80 mol %, or at least 90 mol %, of the total amount of anion present in the electrolyte.

The fluorinated sulfonyl imide(s) and/or methide(s) will typically be introduced to the electrolyte with the metal and optional phosphonium cations, e.g. as a metal salt or phosphonium ionic liquid additive. However, it is not excluded that the negative ions may also, or alternatively, be introduced as counterions to other cationic species in the electrolyte, for example a cationic proton carrier.

### Proton Carrier

The electrolyte comprises a proton carrier. As explained herein, the role of the proton carrier (BH in FIG. 1) is to provide protons for the cathodic reduction of dinitrogen to ammonia. It is proposed that in at least some embodiments this occurs by reaction with a metal nitride intermediate formed on the cathode. The resulting deprotonated proton carrier (B in FIG. 1), now a proton acceptor, may be regenerated in the electrolyte by re-protonation with protons introduced to the electrolyte by the anode reaction. In the overall continuous process, the proton carrier thus carries, or shuttles, protons produced at the anode for reaction at the cathode. Because the protons are intercepted by the deprotonated proton carrier before they reach the cathode, they are not reduced to H₂ via the HER.

It follows that the proton carrier should be reactive with Li₃N or other metal nitride to produce NH₃, but in such embodiments is only weakly acidic in order to diminish the rate of competitive proton reduction to dihydrogen and/or hydride. It is also preferred that the proton carrier can be cycled through multiple deprotonation/regeneration cycles with minimal side reactions. Thus, the proton carrier plays a catalytic role in the process, minimising consumption of the proton carrier reagent and undesirable decomposition reactions on the cathode or anode. While weakly acidic proton carriers capable of shuttling between protonated and deprotonated forms are thus preferred, it is not excluded that the proton carrier may instead be protons (H⁺) or hydronium ions (H₃O⁺).

During the continuous NH₃ synthesis, and particularly at or near steady state operating conditions, the electrolyte may include a mixture of both the proton carrier and its corresponding deprotonated form (the proton acceptor). A continuously operated cell will reach steady state relative concentrations of both species when the production of protons at the anode is exactly matched by their consumption at the cathode (either as the desired NH₃ or by-products such as H₂), provided that other materials (e.g. Li, Li₃N, LiH) are not accumulating. Indeed, the presence of both species in the electrolyte is understood to create a desirable buffering action. The buffering allows the proton carrier to absorb excess proton production at the anode during start up and/or intermittency-driven variations in current. Moreover, operating with a significant concentration of the proton acceptor in the electrolyte ensures that a high proportion of the protons are intercepted and consumed before they can participate in undesirable cathodic reactions such as the HER.

It will be appreciated that suitable concentrations of the proton carrier will depend on the specifics of the overall electrochemical system, including the choice of proton carrier molecule. In some embodiments, the proton carrier and the proton acceptor are present in the electrolyte in a combined concentration of greater than 0.001 mol/L, or greater than 0.01 mol/L, or in the range of between 0.05 mol/L and 0.5 mol/L.

The proton carrier may be neutral or cationic, and may be capable of reversible deprotonation to form a corresponding anionic or neutral proton acceptor. As used herein, reversible deprotonation means that the proton carrier can be deprotonated to form the proton acceptor, which in turn can be re-protonated to regenerate the proton carrier. Consistent with the proposed mechanism, the proton carrier may be capable of deprotonation to the proton acceptor by reacting with a metal nitride such as Li₃N, preferably in solution at room temperature. The proton acceptor may be capable of protonation to form the proton carrier by reaction with free protons and/or an organic acid, preferably in solution at room temperature. The inventors have found that such reactions provide a convenient way to evaluate proton carrier candidates for use in the methods of the invention.

In some embodiments, the proton carrier is a neutral proton carrier capable of reversible deprotonation to form an anionic proton acceptor. A wide range of neutral proton carriers are effective, including alcohols, ethers and acids. In some embodiments, the neutral proton carrier is an alcohol, for example methanol, ethanol, a propanol or a butanol. In some embodiments, the acid is a conjugate acid (protonated form) of a weakly coordinating anion, for example the fluorinated sulfonyl imide(s) and/or methide(s) present in the electrolyte.

In some embodiments, the proton carrier is a cationic proton carrier capable of reversible deprotonation to form a neutral proton acceptor which is an ylide. The cationic proton carrier and its corresponding proton acceptor are typically organic species. The neutral proton acceptor molecule is an ylide, which is a neutral dipolar molecule containing an atom having a formal negative charge directly attached to a heteroatom having a formal positive charge. An ylide is thus a type of zwitterion.

Without wishing to be bound by any theory, it is believed that suitable ylides are capable of reversible interconversion with a cationic proton donor by protonation and deprotonation reactions, as required, because the electrons of the negative charge are partly shared with the empty orbitals of the positive centre. It is believed that this provides the protonated form with acidity in the weakly acidic range required of a proton donor in continuous metal-mediated ammonia synthesis.

In some embodiments, the ylide comprises a carbanion adjacent to a positively charged heteroatom. The proton carrier site on the molecule is thus a carbon atom, which transitions between a carbanion in the deprotonated form to a C—H covalent bond in the protonated form.

In some embodiments, the cationic proton carrier is an alkyl phosphonium cation or an alkyl sulfonium cation, and the neutral proton acceptor is the corresponding phosphonium ylide or sulfonium ylide.

In some embodiments, the cationic proton carrier is a phosphonium cation and the neutral proton acceptor is the corresponding phosphonium ylide. The phosphonium cation may be an alkyl phosphonium cation. As used herein, an alkyl phosphonium cation refers to a phosphonium cation comprising at least one optionally substituted alkyl group. The alkyl phosphonium cation may generally be any such species capable of deprotonating to form a phosphonium-carbanion ylide (R′)₃P⁺—C⁻(R″)₂ where each R′ and R″ organyl group may be the same or different.

The deprotonation of alkyl phosphonium cations to form ylides is known in the field of synthetic organic chemistry, where the ylide is commonly referred to as a Wittig reagent. Phosphonium-carbanion ylides are useful as nucleophilic reagents in a number of synthetic reaction schemes. In the Wittig reaction, for example, the phosphonium ylide reacts with a carbonyl group via [2+2] cycloaddition to form an oxaphosphetane, followed by elimination and generation of alkene and phosphine oxide. Synthetic reactions with ylide reagents are generally driven by the non-reversible conversion of the reactive ylide to a stable species such as phosphine oxide.

By contrast, embodiments of the present invention use the phosphonium ylide as a reversible proton-shuttling agent, intercepting protons in the electrolyte and transporting them for a protonation reaction with nitrogen to form ammonia.

A wide range of alkyl phosphonium cations are considered suitable in the invention subject only to the requirement that they are susceptible to reversible deprotonation to an ylide proton acceptor, for example as depicted in Scheme 1. The alkyl phosphonium cation may thus have a structure of Formula 4 and the corresponding ylide has the structure of Formula 5:

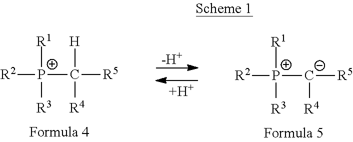

In some embodiments, R¹, R², R³ are independently selected from alkyl (e.g. C₁-C₂₀ n-alkyl groups) and aryl (e.g. phenyl groups), R⁴ is selected from hydrogen, alkyl (e.g. C₁-C₂₀ n-alkyl groups) and aryl (e.g. phenyl groups) and R⁵ is selected from hydrogen, alkyl (e.g. C₁-C₁₉ alkyl groups), cycloalkyl (e.g. C₃-C₆ cycloalkyl groups), alkyl (e.g. C₁-C₁₉ alkyl) or cycloalkyl substituted by halogen, ether, ester, acyl, amino and nitrile functional groups, aryl (e.g. phenyl groups including-C₆F₅), ester (e.g. —C(═O)O(C₁-C₆alkyl), amide (e.g. C(═O)NHC₆F₅, C(═O)N(Me)OMe), nitrile (—CN), halogen, ether (e.g. —O(C₁-C₆alkyl), thioether (e.g. —S(C₁-C₆alkyl), —SC₆F₅), —PR¹⁰R¹¹ and —P(═O)R¹²R¹³, wherein R¹⁰-R¹³ are independently alkyl (e.g. C₁-C₆)alkyl and aryl (e.g. —C₆F₅). The alkyl and aryl groups in any of R¹-R⁴ may be unsubstituted or substituted with substituents such as halogen, ether, hydroxy, ester, acyl, amino and nitrile functional groups, and the like, and any two of R¹-R⁴ may be connected to form a cyclic structure.

As the skilled person will appreciate, the groups R¹-R⁵, and particularly R⁵, may be selected to control the acidity, and thus the proton donating ability, of the alkyl phosphonium cation.

In some embodiments, R¹, R² and R³ are independently selected from C₁-C₂₀ n-alkyl and phenyl, R⁴ is hydrogen and R⁵ is selected from hydrogen and C₁-C₁₉ n-alkyl.

In some embodiments, the alkyl phosphonium cation is an ionic liquid cation, meaning that it is capable of forming an ionic liquid, for example a room temperature ionic liquid, when paired with a suitable counterion. A range of phosphonium cations of general Formula 4, including tetra-alkyl phosphonium cations, form ionic liquids in combination with counterions such as BF₄_{^{−}}, PF₆_{^{−}}, fluoroalkyl phosphates including tris(pentafluoroethyl)trifluorophosphate (eFAP), fluoroalkyl borates such as tetrakis [hexafluoroisopropyl]borate, fluorinated bis(sulfonyl)imides including bis(fluorosulfonyl)imide, bis(trifluoromethanesulfonyl)imide and (fluorosulfonyl)-(trifluoromethanesulfonyl)imide and fluorinated sulfonates including triflate and other perfluoroalkylsulfonates. Ionic liquids of this type have been used, without dissolved metal cations, in the context of nitrogen reduction in the prior art (e.g. MacFarlane et al, WO 2017/132721 A1), however at the cathode potentials disclosed in the prior art, these ionic liquid do not show any tendency to deprotonate. At the more significantly negative potentials required in the present case, for example more negative than −2.0 V vs Ag/Ag⁺, to achieve metal nitride formation these ionic liquids can become active proton donors (particularly in the absence of a more reactive neutral proton carrier).

In some embodiments, the alkyl phosphonium cation is a tetra-alkyl phosphonium cation. The tetra-alkyl phosphonium cation may have the structure [PR⁶R⁷R⁸R⁹]⁺, wherein R⁶, R⁷, R⁸ and R⁹ are independently selected from C₁-C₂₀ n-alkyl. In some embodiments, the combined sum of the carbon atoms in R⁶, R⁷, R⁸ and R⁹ is at least 7, or at least 13, or at least 16. As the skilled person will appreciate, an increase in the combined chain length of the tetra-alkyl phosphonium cation will generally increase its solubility in organic media, reduce the melting point of its salts and decrease its tendency to absorb or dissolve water. In some embodiments, R⁶, R⁷ and R⁸ are independently selected from C₄-C₂₀ n-alkyl and R⁹ is a C₁-C₂₀ n-alkyl.

The proton carrier system may be introduced to the chemical cell in its protonated form, for example by dissolving a neutral proton carrier or a suitable salt of a cationic proton carrier species in the electrolyte. However, it will be appreciated that either the protonated proton carrier or the corresponding proton acceptor may initially be supplied to the electrochemical cell to facilitate the NH₃ synthesis reaction; a mixture of the two species may be formed in situ in both cases as explained above.

### Solvent

The electrolyte is typically a liquid, preferably with a viscosity which is sufficiently low that mass transfer limitations are avoided or acceptably low. In some embodiments, the electrolyte has a viscosity of less than 50 MPa s, or below 20 MPa s, or below 15 MPa s at 25° C. This viscosity may be measured according to ISO 12058 with a Lovis 2000M Anton Paar viscosimeter (Lovis angle of 30°).

The electrolyte may thus include one or more non-aqueous solvents. Suitable non-aqueous solvents are generally aprotic solvents, for example aprotic molecular solvents. The solvent should preferably be stable under the reaction conditions, or at most degrade to a small extent.

In some embodiments, the electrolyte comprises one or more molecular solvents selected from the group consisting of ethers, polyethers (e.g. methylated polyethers), glycol ethers (e.g. methylated glycol ethers such as tetraglyme), fluorinated ethers, fluorinated alkyls, fluorinated cycloalkyls, carbonates, sulfolane and dimethylsulfoxide. An example of a suitable ether solvent is tetrahydrofuran (THF).

In some embodiments, the electrolyte comprises an aprotic donor solvent capable of solvating the metal cations. Examples of suitable solvents include THE, cyclopentyl methyl ether (CPME), carbonates, dimethoxyethane, glymes, dioxolane. Without wishing to be limited by any theory, it is proposed that such solvents may facilitate the required high concentrations of metal cation in the electrolyte by coordinating to the metal cations. Moreover, the presence of the aprotic donor solvent may advantageously enhance the conductivity of the highly ion-concentration electrolyte liquid by facilitating charge separation between the metal cations and the anions. The aprotic donor solvent may thus be present in a concentration sufficient that each metal cation can be solvated by multiple aprotic donor solvent molecules.

In some embodiments, the liquid electrolyte comprises a room temperature ionic liquid solvent, for example in an amount of at least 20 wt. %, or at least 50 wt. % of the total non-aqueous solvent in the electrolyte. Without wishing to be limited by any theory, certain ionic liquid solvents may be useful to assist with solvation of the metal cation and/or to increase N₂ solubility in the electrolyte. Optionally, the ionic liquid comprises, as the anion, the at least one negative ion selected from the group consisting of fluorinated sulfonyl imides, fluorinated sulfonyl methides and combinations thereof.

However, it has been found by experiment that some ionic liquid cations adversely affect the dinitrogen reduction reaction, possibly because they decompose irreversibly at the cathodic potentials required to drive the metal-mediated NRR. In some embodiments therefore, the ionic liquid is not an imidazolium- or pyrrolidinium-based ionic liquid. In some embodiments, the cation of the ionic liquid is not an organonitrogen cation. By contrast, phosphonium-based ionic liquid additives have been found capable of enhancing faradaic efficiency and yield rate, particularly at low N₂ pressures. Such ionic liquids are thus either sufficiently stable, or desirably reactive (as a cationic proton carrier), under the conditions of the metal-mediated NRR.

The electrolyte of the present disclosure may be a non-aqueous electrolyte, so that water is not present as the solvent or proton carrier. The non-aqueous electrolyte is preferably substantially free of water, meaning that the amount of water is zero or low enough that it does not interfere to a significant extent with the reaction cycle of the continuous, metal-mediated electrochemical NH₃ synthesis reaction as disclosed herein. For example, it may contain no more than 1000 ppm of water, preferably less than 100 ppm and most preferably less than 20 ppm.

### Cathode, Anode and Power Supply

The methods of the present disclosure are generally performed in an electrochemical cell comprising a cathode, an anode and a power supply connected to the cathode and the anode. The power supply is configured to apply a voltage between the cathode and the anode sufficient to drive the electrochemical ammonia synthesis.

The cathode may be any conductive electrode which is stable at the required reduction potential, for example metallic electrodes as used in previously reported lithium-mediated continuous electrochemical syntheses (e.g. Tsuneto et al, Chemistry Letters 1993, 851-854) or other processes involving reduction of the metal cations to the metallic form. Non-limiting examples of suitable metals may include Ni, Nb, Ti, Mo, Fe, Cu, Ag and Zn and alloys thereof. In other embodiments, the metal of the cathode comprises or consists of the metal which mediates the ammonia synthesis (e.g. metallic lithium).

While the generally understood mechanism of the lithium-mediated nitrogen reduction reaction does not imply an electrocatalytic role for the cathode, it has nevertheless surprisingly been found that the choice of cathode material can affect the yield rate and faradaic efficiency. Without wishing to be limited by any theory, it is proposed that a protective ionic assembly, comprising bulky and electrochemically stable anions and metals cations in an electrolyte-electrode interface layer, forms at the cathode surface during the synthesis. While the electrolyte composition as disclosed herein is considered the primary contributor to the improved ammonia synthesis results, the cathode surface composition may play a secondary role in facilitating the formation of a desirable ionic assembly. In some embodiments, the cathode comprises metallic nickel, niobium or copper, preferably nickel or niobium, and most preferably nickel.

The cathode can be a cylinder, disc, plate or other shape appropriate for the cell design. The cathode may additionally be porous, for example as achieved by etching or be constructed as a foam or as a mass of compressed particles or via an inverse opal structure. The desired mediator metal may also be coated by for example electrodeposition or chemical deposition onto an underlying structure that provides optimum roughness and porosity. The cathode may also be formed by depositing metal nanoparticles into an otherwise inert structure.

An advantage of some embodiments disclosed herein is that deleterious fouling of the cathode may be avoided or minimised during ongoing electrochemical reduction of dinitrogen. Instead, the formation of a very thin (<10 nm) and coherent solid interfacial layer, comprising solid LiF, S—O species and intact fluorinated sulfonyl imide anion, was observed. Without wishing to be limited by any theory, this layer may be merely benign or it may beneficially mediate the reduction processes taking place at the cathode surface. In some embodiments, therefore, the cathode comprises a surface which is coated with a thin, solid interfacial layer comprising LiF (and optionally also S—O species and/or intact fluorinated sulfonyl imide or methide anions) under electrochemical reduction conditions, for example after producing ammonia for 6 hours. This layer may be produced in situ by electroreduction of the electrolyte, or by another suitable technique, for example electroreductive coating or other synthesis of the solid interfacial layer on the cathode surface in a preliminary step.

Suitable anodes for oxidation of hydrogen-containing species, such as H₂O or H₂, to form protons are well known in the field of electrochemistry. In some embodiments, the anode is a platinum electrode.

The power supply may be any conventional power supply for electrolysis systems, such as a direct current power source. Optionally, the power supply may include a photovoltaic solar cell. It is considered a particular advantage of the present invention that ammonia may be produced from electrical power, and particularly renewable power. For example, it is envisaged that the invention may allow ammonia-based fertilizers to be produced at the point of need using solar or wind-generated power; this may be particularly valuable for high value agricultural applications such as hydroponics, or to minimise logistical challenges associated with fertilizer transport to remote areas.

### Cathodic Reduction of Dinitrogen to Ammonia

The methods of the present disclosure include supplying dinitrogen to the electrochemical cell for cathodic reduction, and applying a potential at the cathode sufficient to reduce the dinitrogen, thereby producing ammonia. The resultant current flow from the cathode to the anode through the electrolyte produces an increasing yield of ammonia with time.

It will be appreciated that “cathodic reduction”, as used herein, does not indicate any particular mechanism, specify intermediate species involved in the reaction cycle or imply where these species react (e.g. on the cathode surface or in the bulk electrolyte). However, without wishing to be bound by any theory, it is proposed that the dinitrogen is cathodically reduced to ammonia according to the mechanism disclosed herein with reference to FIG. 1. The overall cathodic nitrogen reduction reaction is thus considered to be as shown in equations (3) and (4) for neutral [B—H] and cationic [B—H]⁺ proton carriers respectively:

$${N}_{2} + 6 [ B ‐ H ] + 6 {e}^{-} \to 2 {NH}_{3} + {6 [ B ]}^{-} \qquad ( 3 )$$

$${N}_{2} + {6 [ B ‐ H ]}^{+} + 6 {e}^{-} \to 2 {NH}_{3} + 6 [ B ] \qquad ( 4 )$$

The dinitrogen may be supplied to the electrochemical cell for cathodic reduction at a dinitrogen partial pressure of greater than 1 bar, or greater than 5 bar, or greater than 10 bar. In some embodiments, the dinitrogen partial pressure is in the range of 0.7 bar to 100 bar, or 2 bar to 30 bar, or 5 bar to 20 bar, or 10 bar to 15 bar. Elevated partial pressures of N₂ in the cell may improve the yield rate and faradaic efficiency of the ammonia synthesis by increasing the concentration of N₂ dissolved in the electrolyte. This is believed to favour the desired reaction between N₂ and the metallic metal to form metal nitride.

The dinitrogen may be supplied to the electrochemical cell for cathodic reduction by contacting the electrolyte with dinitrogen, thereby solubilising the dinitrogen in the electrolyte. Preferably the dinitrogen is predominantly, or exclusively, present in the solution phase when exposed to the cathode. It has been found that electrolyte decomposition is accelerated on regions of the cathode exposed to gaseous dinitrogen at a static gas-electrolyte meniscus (cathode/electrolyte/N₂ gas). Without wishing to be bound by any theory, this undesirable process is attributed to the very high concentration gradient of dinitrogen and the depletion of the proton carrier across the static gas-electrolyte meniscus, which induces excessively high rates of metal nitride and/or metal(0) formation on the cathode and uncontrollable electroreductive transformations of the electrolyte. Enhanced electrolyte decomposition at the electrode-electrolyte-gas static gas-electrolyte meniscus may consume a significant portion of charge, thereby decreasing the faradaic efficiency, and the resultant insoluble deposits may inhibit mass transfer to the cathode, thereby destabilising the reaction system. In some embodiments, therefore, the cathode is not contacted with gaseous dinitrogen at a static gas-electrolyte meniscus when producing the ammonia. To achieve this, the electrochemically active portion of the cathode may be entirely immersed in the electrolyte.

It will be appreciated that the absolute cathode potentials sufficient to reduce the dinitrogen and the proton carrier will depend on various factors, including the choice of metal cation. When lithium cations are used, the cathode potential may be below (more negative than) −2.0 V vs Ag/Ag⁺.

In some embodiments, the cathode potential is below (more negative than) the apparent reduction potential of the metal cations to the corresponding reduced form, e.g. the metallic form and/or metal nitride (the apparent Li⁺/Li reduction potential). As used herein, the apparent reduction potential is the reduction potential of the metal cations in the electrolyte under dinitrogen reduction conditions, as measured by the crossover point in cyclic voltammetry. In some embodiments, the cathode potential is below (more negative than) −0.2 V, or −0.4 V, relative to the apparent reduction potential of the metal cation in the electrolyte. At such negative potentials, excellent yield rates and faradaic efficiencies may be obtained. In some embodiments, however, the cathode potential is above (more positive than) −1 V, or −0.8 V, relative to the apparent reduction potential of the metal cation in the electrolyte. More negative potentials than this may enhance undesirable electrolyte decomposition reactions.

The electrolyte may be maintained at a suitable temperature to facilitate the ammonia synthesis. The temperature may be in the range of −35° C. to 200° C., such as 15° C. to 100° C.

The dinitrogen may be reduced to ammonia with a faradaic efficiency of at least 30%, or a least 40%, or least 50%, or at least 60%, such as at least 70%, or at least 80%. Such high faradaic efficiencies are highly desirable due to the minimisation of the by-products and energy loss per unit of ammonia produced.

The product ammonia is expected to speciate in the electrolyte as NH₃ rather than NH₄_{^{−}}, since the ammonium cation is typically a stronger acid than the proton carrier. However, if excess protons are produced, it is not excluded that some ammonia in the form of NH₄_{^{−}} may be produced. The product ammonia is also expected to be released into a gas phase.

### Anodic Oxidation

The methods of the present disclosure may include introducing protons to the electrolyte by anodic oxidation of a hydrogen-containing species at the anode of the electrochemical cell. According to the principles disclosed herein, the protons are expected to react with the proton acceptor in the electrolyte, thereby regenerating the cationic proton carrier. It is the latter species, rather than the protons themselves, which is believed to be the primary protonating agent involved in the nitrogen reduction reaction.

The protons may be produced at the anode of the electrochemical cell by oxidation of any suitable hydrogen-containing species, including dihydrogen (H₂) and water (H₂O). In the case of H₂ oxidation, the overall anodic regeneration process for the proton carrier, is shown in either equation (4) for a neutral proton carrier [B—H] or equation (5) for a cationic proton carrier [B—H]⁺. The corresponding reactions for anodic H₂O oxidation are shown in equations (6) and (7).

$$3 {H}_{2} + {6 [ B ]}^{-} \to 6 [ B ‐ H ] + 6 {e}^{-} \qquad ( 4 )$$

$$3 {H}_{2} + 6 [ B ] \to {6 [ B ‐ H ]}^{+} + 6 {e}^{-} \qquad ( 5 )$$

$$3 {H}_{2} O + {6 [ B ]}^{-} \to 3 / 2 {O}_{2} + 6 [ B ‐ H ] + 6 {e}^{-} \qquad ( 6 )$$

$$3 {H}_{2} O + 6 [ B ] \to 3 / 2 {O}_{2} + {6 [ B ‐ H ]}^{+} + 6 {e}^{-} \qquad ( 7 )$$

When H₂ is oxidised to produce the protons, the electrolyte may be in contact with both the cathode and the anode. The protons are thus directly introduced to the electrolyte when formed at the anode. H₂ may be obtained from any source, including from the electrolysis of water with renewable power. Optionally, a water electrolysis cell can be integrated with the nitrogen reduction cell to supply the H₂ directly from electrolysis to nitrogen reduction.

Due to its low cost, water is a particularly desirable source of protons in electrochemical syntheses, but is known to interfere with the metal-mediated continuous NRR. Therefore, for the case where H₂O is oxidised to produce the protons, an indirect transfer of protons from the anode to the electrolyte may be preferred. This may help to acceptably limit or avoid the presence of water in the electrolyte where nitrogen reduction takes place. For example, the electrochemical cell may comprise two electrolytes: a catholyte comprising the metal cations, fluorinated sulfonyl imide or methide anions and proton carrier (as generally disclosed herein) and an anolyte (either liquid, or solid or mixed liquid-solid) in contact with the anode where water is oxidised. The electrochemical cell is configured to allow proton transfer from the anolyte to the catholyte, but to substantially limit or avoid water transfer. Various arrangements to achieve this are known in the field of electrochemical synthesis, as will be explained in greater detail hereafter.

Although the methods disclosed herein generally provide high faradaic efficiencies, H₂ may in some embodiments be formed as a significant by-product of the nitrogen reduction reaction due to competition from the HER at the cathode. The H₂ by-product may optionally be recycled for oxidation at the cathode, supplementing the feed of the chosen hydrogen-containing species. This results in reduced energy consumption per unit of ammonia produced as there is no other energy containing by-product.

### Electrochemical Cell

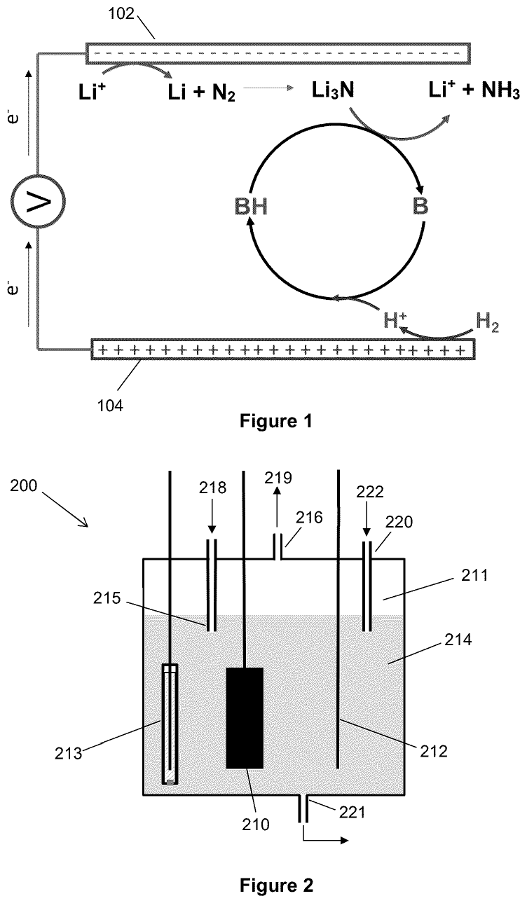

An example of an electrochemical cell for performing embodiments of the invention is schematically depicted in FIG. 2. Cell 200 includes nickel cathode 210 in cell chamber 211. Cell 200 further comprises platinum anode 212, and optionally reference electrode 213 of conventional type, such as Ag/Ag⁺. The three electrodes are immersed in the same liquid electrolyte 214, which comprises lithium cations (>1 mol/L, or >0.5 mol/L together with phosphonium cations in combined concentration of >1 mol/L), fluorinated sulfonyl imide anions (e.g. TFSI) as the only weakly coordinating anion and a proton carrier (e.g. ethanol) in THF. The entire conductive surface of cathode 210 is fully submerged below the electrolyte surface, so that it is not exposed to gaseous N₂ during the reaction. Optionally, a stirrer or other means for mixing or circulating the electrolyte may be included to provide intensified mass transport in cell chamber 211. The electrodes are connected to a power source (not shown) capable of applying a voltage between cathode 210 and anode 212, with the reduction potential of the cathode controlled (or measured) relative to the reference electrode.

Cell 200 further comprises gas inlet 215 to introduce gas mixture 218, comprising dinitrogen (N₂) and dihydrogen (H₂), to chamber 211. The cell may include gas outlet 216 for removing gas 219 from the headspace of the chamber, electrolyte inlet 220 for replenishing the electrolyte with electrolyte feed 222, and electrolyte outlet 221 for withdrawing electrolyte 214. The cell is preferably configured for operation at elevated pressures.

In use, gas mixture 218 is pressurised into chamber 211 via feed inlet 215, and a voltage is applied between the cathode and the anode sufficient to establish a reduction potential at cathode 210 which is below (more negative than) the apparent Li⁺/Li reduction potential. The partial pressure of dinitrogen in cell chamber 211 may be greater than 10 bar, and that of dihydrogen greater than 1 bar. The resulting flow of current through the cell electrochemically reduces dinitrogen to ammonia according to the principles disclosed herein. The ammonia product may be removed continuously or periodically from cell chamber 211 in gas 219 via gas outlet 216 and/or in electrolyte 214 withdrawn via electrolyte outlet 221.

In some embodiments, the cell is operated at steady state by continuously withdrawing one or both of these flows, and continuously replenishing the gas reactants (N₂ and H₂) and/or electrolyte by introducing gas mixture 218 and/or electrolyte feed 222 as required. The ammonia may be separated from the withdrawn streams of gas 219 and/or electrolyte 214, and the residual gas and electrolyte may be recycled to cell chamber 211 as part of gas mixture 218 and electrolyte feed 222 respectively. A portion of the electrolyte 214 withdrawn via electrolyte outlet 221 may be discarded (or regenerated) and replaced with fresh electrolyte in feed 222, thus maintaining a target electrolyte residence time in the cell.

In one embodiment of a point of use fertiliser generating cell, the exiting gas stream 219 is passed through a solution of sulphuric or phosphoric acid in water to absorb the ammonia as ammonium (NH₄_{^{−}}). The product of this process is a solution of the ammonium salt of the acid used, for example ammonium sulphate solution, and can be applied directly as a fertilising solution. In the case of hydroponic or commercial greenhouse use, the cell can be controlled to continuously provide a supply of fertiliser in-line in the water supply to the plants.

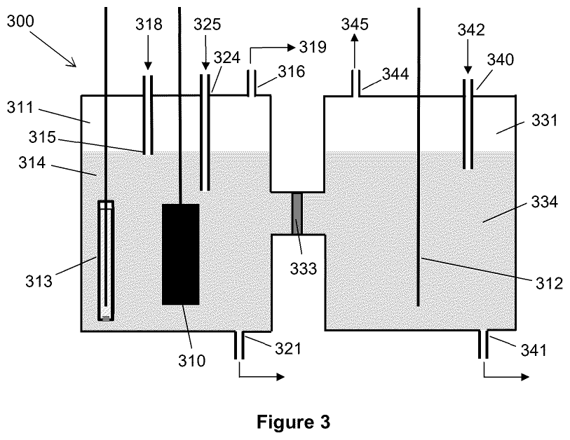

Another example of an electrochemical cell for performing embodiments of the invention is schematically depicted in FIG. 3. Cell 300 includes cathodic chamber 311 and anodic chamber 331, which are separated by proton-permeable membrane separator 333, for example a membrane made of a sulfonated poly(tetrafluorethylene) ionomer such as Nafion. Nickel cathode 310 is disposed in cathodic chamber 311. Reference electrode 313 of conventional type is also in the cathodic chamber. Platinum anode 312 is disposed in anodic chamber 331. The electrodes are connected to a power source (not shown) capable of applying a voltage between cathode 310 and anode 312, with the reduction potential of the cathode controlled (or measured) relative to the reference electrode.

Cathode 310 and reference electrode 313 are immersed in catholyte 314, while anode 312 is immersed in anolyte 334. Catholyte 314 is a liquid electrolyte which comprises lithium cations (>1 mol/L, or >0.5 mol/L together with phosphonium cations in combined concentration of >1 mol/L), fluorinated sulfonyl imide or methide anions and a proton carrier as generally disclosed herein. Anolyte 334 includes water for oxidation at the anode, but otherwise may be the same or different in composition compared to catholyte 314. Membrane separator 333 inhibits or substantially prevents the transmission of species other than protons between the cathodic and anodic reaction chambers.

Cell 300 further comprises gas feed inlet 315 to introduce dinitrogen feed 318 to cathodic chamber 311. The cell may include cathodic gas outlet 316 for removing gas 319 from the headspace of the cathodic chamber, catholyte inlet 324 for replenishing the catholyte with catholyte feed 325, and catholyte outlet 321 for withdrawing catholyte 314. Cell 300 may comprise anodic inlet 340 for introducing or replenishing anolyte 334, and optionally also to introduce one or more hydrogen-containing species to anodic chamber 331 (e.g. H₂O as either liquid or vapour and/or H₂). Anolyte outlet 341 is provided for withdrawing anolyte 334, and anodic gas outlet 344 is provided for withdrawing gases 345 from the anodic chamber headspace.

In use, dinitrogen 318 is pressurised into cathodic chamber 311 via gas feed inlet 315. The partial pressure of dinitrogen in cathodic chamber 311 may be greater than 10 bar. Water may initially be present in anolyte 344 and/or fed to the anodic chamber via anodic inlet 340. A voltage is applied between the cathode and the anode sufficient to establish a reduction potential at cathode 310 which is below (more negative than) the apparent Li⁺/Li reduction potential. The resulting flow of current through the cell electrochemically reduces the dinitrogen to ammonia in cathodic chamber 311 according to the principles disclosed herein.

In cell 300, differently from cell 200, water is oxidised at anode 312 to produce protons in anolyte 334. The protons migrate across membrane separator 333 to maintain charge neutrality in the cell, where they enter catholyte 314 and regenerate the proton carrier by protonating the proton acceptor. However, water and other undesirable species are excluded or inhibited from migrating from anolyte 334 to catholyte 314 by membrane separator 333.

The ammonia product may be removed continuously or periodically from cathodic chamber 311 in gas 319 via gas outlet 316 and/or in catholyte 314 withdrawn via electrolyte outlet 221. The cell may be operated continuously, and the electrolytes and gases withdrawn from the cell may be recycled, after removal of ammonia and other by-products, in similar manner as described for cell 200. Any dihydrogen produced as a by-product in cathodic chamber 311 may be recovered and recycled to anodic chamber 331 for oxidation.

In a variation, dihydrogen may be introduced to cell 300 as the only hydrogen-containing species for oxidation at anode 312. In this case, both catholyte 314 and anolyte 334 may be substantially free of water.

The arrangement depicted in cell 300 is only one example of an electrochemical cell configured to allow oxidation of water at the cathode, and selective transmission of the resultant protons to a substantially water-free electrolyte for participation in water-sensitive cathodic reactions. In another reported approach, a separator is positioned in proximity to a porous anode (e.g. a gas diffusion electrode). A gas stream containing some water, e.g. humid air, is directed across the outside face of the anode, with the separator impeding convective mixing. The electrolyte is sufficiently hydrophobic that little water is absorbed from the gas stream. If the hydrophobicity of the electrolyte and the gas flow humidity are adequately tuned, the separator may not require proton-selective properties to maintain a low water content in the bulk electrolyte.

In another reported approach, a hydrophobic organic catholyte and polar (e.g. aqueous) anolyte are immiscible, and proton transfer takes place across the phase boundary between them. This arrangement may also allow satisfactory proton transfer while adequately inhibiting water transmission into the catholyte. To maintain a stable phase boundary a separator may be used as the location of the boundary.

### EXAMPLES

The present invention is described with reference to the following examples. It is to be understood that the examples are illustrative of and not limiting to the invention described herein.

### Materials and Methods

Copper metal wire (diameter 1.3 mm; 99.99%) was purchased from Fisher Scientific. Nickel wire (diameter 0.5 and 2 mm, ≥99.9% trace metals basis) was purchased from Sigma-Aldrich. Niobium foil (0.127 mm thickness, 99.8% trace metals basis) was purchased from Alfa Aesar.

Lithium perchlorate (LiCO₄, 99.99%) and lithium trifluoromethanesulfonate (LiOTf, 96%) were supplied by Sigma-Aldrich. Lithium tetrafluoroborate (LiBF₄, 98%) was purchased from Acrōs Organics. Lithium bis(trifluoromethanesulfonyl)imide (LiTFSI; >99%; HQ-115, LOT 10197) was purchased from 3MFluorad. Lithium bis(fluorosulfonyl)imide (LiFSI) was received from Nippon Shokubai, Japan.

Ethanol (anhydrous, 95%) and triethylsulfonium bis(trifluoromethanesulfonyl)imide (EtsS-TFSI) was purchased from Sigma-Aldrich. Tetrahydrofuran (stabilised with BHT, analytical grade), soluble starch and phosphoric acid (85 wt. %) were sourced from Chem-Supply. Dimethyl sulfoxide-d₆ (DMSO-d₆; D, 99%) was obtained from Cambridge Isotope Laboratories Inc., UK. Sulfuric acid (98%) and acetone were supplied by Univar Solutions. NH₄Cl (>99%), NaOH (pellets, analytical grade), salicylic acid (>99%), tri-sodium citrate dihydrate (analytical grade), sodium hypochlorite (10-15 wt. % chlorine), sodium nitroprusside dihydrate (≥99%) and maleic acid (≥99%) were purchased from Sigma-Aldrich and Merck. High-purity deionised water (Sartorius Arium Comfort I ultrapure water system H₂O—I-1-UV-T; measured resistivity 18.2 MΩ cm at 23±2° C.) was used in all procedures that required water. High purity grade N₂ (99.999%; CO₂<1 ppm, O₂<2 ppm, H₂O<2 ppm) and Ar (99.999%; CO₂<1 ppm, O₂<2 ppm, H₂O<2 ppm) gases were purchased from BOC Australia.

The phosphonium and sulfonium salts trihexyl(tetradecyl) phosphonium tris(pentafluoroethyl) trifluorophosphate; ([P_{666,14}][eFAP]), tributyl(octyl) phosphonium tris(pentafluoroethyl) trifluorophosphate; ([P_{444,8}][eFAP]), trihexyl(tetradecyl) phosphonium bis(trifluoromethanesulfonyl)imide ([P_{666,14}][TFSI]), triethyl(methyl) phosphonium tris(pentafluoroethyl) trifluorophosphate; ([P₁₂₂₂][eFAP]) and triethylsulfonium bis(trifluoromethanesulfonyl)imide [EtsS][TFSI] were synthesized according to previously published methods.

Electrolyte solutions were prepared using tetrahydrofuran that was dried over activated zeolite “molecular sieves” (3 Å, Sigma-Aldrich) for 1 day and then stored over another fresh portion of activated zeolite in Ar-filled glovebox (Korea Kiyon; O₂≤0.6 ppm and H₂O≈0.0 ppm levels were continuously monitored). All lithium salts were dried at elevated temperatures under vacuum in a glovebox antechamber and then transferred inside the glovebox without exposure to ambient environment. Specifically, LiBF₄ and LiFSI were dried at 80° C. for 12 h, while LiClO₄, LiOTf and LiTFSI were dried at 120° C. for 24 h.

Electrolyte solutions were prepared by dissolving the dried lithium salts at required concentrations in dried THF using volumetric flasks inside the Ar-filled glovebox. Ethanol was kept over activated zeolite for at least 5 days inside the Ar-filled glovebox before being used as a proton carrier. All chemicals required for the preparation of the electrolyte solutions as well as prepared and used electrolyte solutions were stored inside the Ar-filled glovebox at all times.

Electrochemical experiments were undertaken at ambient temperature (23 ±2° C.) in a gas-tight polyether ether ketone (PEEK) autoclave cell operated with a Biologic VSP electrochemical workstation in a three-electrode configuration. The working and reference electrodes were located in the centre of a helical coil (d=16 mm) of the auxiliary electrode.

The working electrodes (cathode) used were copper foil (electroactive area 0.62 cm²), copper wire (0.74 cm²), niobium foil (0.18 cm²), bare nickel wire (Ø 0.5 mm; 0.15 cm²), isolated nickel wire (Ø 0.5 mm; 0.05 cm²) or nickel disc (Ø 2 mm; 0.031 cm²). Copper wire, niobium foil and nickel wire were used as received from commercial suppliers. Copper foil was press-rolled from the copper wire into a plate with a thickness of 0.39 mm. The current collector for the copper foil was a copper wire. A nickel disc electrode was custom made by confining a nickel wire (Ø 2 mm) within a Teflon sheath leaving only the flat end exposed to the electrolyte solution on one side. The isolated Ni wire electrode was fabricated by glass-blowing a nickel wire (Ø 0.5 mm) into a glass sheath leaving 3 mm of the wire exposed to the electrolyte solution. Prior to use, all working electrodes, except for nickel disc and niobium foil, were directly electropolished in a continuously stirred (Teflon-lined magnetic stirrer; 1000 rpm) phosphoric acid (85% aqueous solution) containing soluble starch (1:1000 w/v) for 2 min at an applied voltage of 5 V using a DC power supply (Powertech, MP-3091). Electropolished electrodes were rinsed with absolute ethanol and dried with a compressed nitrogen blow gun. Prior to electropolishing for 1 min following the above procedures, nickel disc electrode was mechanically polished (at least 150 figures of “8” until mirror finish) using a polishing pad cloth and a slurry of alumina (0.3 μm, Buehler) in ethanol. The niobium foil electrode could not be electropolished following the procedure above and was only rinsed and wiped with ethanol before use.

The auxiliary electrode in the electrochemical experiments was a platinum wire, which was washed by ultrasonication (40 KHz, 120 W) in absolute ethanol for 1 h, dried under a flow of compressed nitrogen and then flame-annealed using a propane-butane burner. As a quasi-reference electrode, a silver wire confined within a fritted glass tube filled with the same electrolyte solution as in the main compartment was used. Prior to each experiment, the fritted tube was washed with absolute ethanol under ultrasonication (40 KHz, 120 W) for 30 min and then additionally by pushing ethanol through the frit under nitrogen gas pressure. After repeating these procedures 3 times, the fritted tube was dried in an oven at 120° C. for 1 h and then at 80° C. under vacuum for 20 min. The potential of the employed silver wire quasi-reference electrode was calibrated against the apparent potential of the lithium (0/+) process, which was estimated from the crossover point in cyclic voltammetry. The potential measured in this manner is not a true potential of the Li⁺+e⁻⇄Li⁰ redox couple as it is affected by the chemical reactions of Li⁰ with N₂, ethanol and possibly tetrahydrofuran under conditions employed herein. Therefore, it is referred to herein as an apparent lithium (0/+) potential (Li/Li⁺).

Prior to introduction into the glovebox for assembly, the cell was soaked in 0.1 M KOH_{(aq.)} and then in 0.05 M H₂SO_{4(aq.)} for several hours in each solution, followed by an intense wash with water and then absolute ethanol. This washing procedure has proven to be highly efficient for removal of any residual ammonia and other unwanted contaminants, including oxidised forms of nitrogen (NOₓ), that might interfere with the NRR. The cell was dried by flushing with compressed nitrogen flow and in an oven at 120° C. for 1 h. All volumetric flasks, containers, vials and other labware used to prepare and store the solutions and chemicals before and after the electrochemical experiments were washed with water and absolute ethanol, and dried following the same procedures as those employed for the cell.

After completion of the cleaning procedures, all components of the electrochemical cell along with the required labware were dried under vacuum at 80° C. in the glovebox antechamber for at least 15 min. The cell was introduced into the Ar-filled glovebox for assembly and filling of the different compartments with the electrolyte solutions as required. The cell was then sealed and removed from the glovebox for pressurising with N₂ in a manner that excludes penetration of air into the interior of the cell. Unless stated otherwise, no hydrogen was introduced into the cell in order to avoid any contribution from H₂ reduction to LiH in the cathodic process. In the absence of H₂, the proton-forming anode reaction is the oxidation of THF.

The system was allowed to equilibrate for ca 30 min while stirring the electrolyte solution in the main chamber with a Teflon-lined magnetic stirring bar (l=10 mm and d=3 mm) at 600 rpm. The electrochemical reduction reactions were then performed, with key experiments reproduced at least three times and the corresponding data are presented as mean±one standard deviation.

After completion of the experiment, the pressurised gas was slowly released (ca 10 mL min⁻¹) through a trap filled with 15 mL of aqueous 0.05 M H₂SO₄ to capture any gaseous ammonia. The amount of NH₃ in the trap was always at least two orders of magnitude lower than that found in the working electrolyte solution. Therefore, all yield rate and faradaic efficiency data are based on the amount of ammonia produced in the working electrolyte solution only.

Due to high amounts of ammonia produced in the experiments, dilution of post-reaction electrolyte solutions with water by a factor of 10-4000 was required. Acid trap solutions accumulated significantly lower concentrations of NH₄_{^{−}}, but still required dilution (with 0.05 M H₂SO_{4(aq.)}) by a factor of up to 10. To ensure reliable quantification, application of at least two significantly different dilutions to the same sample was used for key experiments.

Spectrophotometric Berthelot analysis (Analyst 109, 549-568 (1984); ACS Energy Letters 5, 736-741 (2020)) was employed for the routine quantification of ammonia. To this end, 500 μl of the sample was added to a 2 ml Axygen microtube and mixed with 400 μl of 1 M NaOH (aq.) containing 5 wt. % salicylic acid and 5 wt. % tri-sodium citrate. This was followed by the sequential addition of 100 μl of 0.05 M NaClO_{(aq.)} and 30 μl of 1 wt. % sodium nitroprusside aqueous solution. The resulting homogeneous mixture was incubated in the dark at ambient temperature for exactly 2 h and then immediately transferred into a polystyrol/polystyrene 10 mm cuvette (Sarstedt) for recording a UV-vis spectra (Cary spectrophotometer) within a 500-1000 nm range at a scan rate of 10 nm s⁻¹. Background spectra were recorded for each sample using Berthelot's reagents solution in water and 0.05 M H₂SO_{4(aq.)} for the analysis of the electrolyte and trap solutions, respectively. All absorbance data are reported after correction for the background values.

Quantification of ammonium in the acid trap was based on a calibration curve constructed using standard 5-100 μM NH₄Cl solutions in 0.05 M H₂SO_{4(aq.)}. The dependence of absorbance at 655 nm (A) on the NH₄⁺ concentration (C_{NH}_{₄}⁺) was linear according to the relationship A=0.0091C_{NH}_{₄}⁺/μM+0.019 (R²=0.99).

Reliable quantitative Berthelot analysis of the electrolysed tetrahydrofuran solutions could not be achieved using a regular calibration approach, and required the implementation of the method of standard additions to account for the interfering effects of the environment specific to each sample. In a typical procedure, 1 ml of the diluted sample was added into six Axygen microtubes (2 ml), to which 1 mL of 0, 10, 20, 30, 40 or 50 μM NH₄Cl in H₂O was added. The resulting 6 mixtures were further analysed following the standard Berthelot spectrophotometric method described above. Plots of the absorbance at 655 nm vs. concentration of added NH₄Cl were fitted with a linear dependence, which Y-intercept was divided by the slope to obtain the negative inverse of X-intercept. The latter corresponds to the ammonia concentration in the analysed diluted sample.

¹H NMR spectroscopic analysis of ammonia was carried out using a Bruker Avance III 600 MHZ (14.1 Tesla magnet) instrument with a 5 mm CPTCl ¹H, ¹³C, ¹⁵N, ²D autotuneable cryoprobe with Z-gradients and BACS 60 tube autosampler set to 1H at 600.27 MHz. The procedure for measurements followed the lc1pncwps pulse sequence (512 scans, d1 1.5 s, p12 0.08 s), a 1D version of noesyprph that uses pre-saturation during relaxation delay and mixing time, shaped pulses for off-resonance pre-saturation and cw-decoupling on the f2 channel during acquisition.

Samples were prepared by sequential mixing 50 μL of 4 M H₂SO₄ in DMSO-d₆, 125 μL of 4.3 mM maleic acid in DMSO-d₆, 740 μL DMSO-d₆, 125 μL of the solution to be analysed and 10 μL H₂O. Ammonia signal integrals were normalised to the integral of the maleic acid internal standard peak (set to 2.0). Calibration plots were constructed for the standard 0-1 M ¹⁴NH₄Cl and ¹⁵NH₄Cl tetrahydrofuran solutions also containing 2 M LiTFSI and 0.1 M C₂H₅OH. The dependence of the normalised ammonia integral (/NH₄_{⁺}) on NH₄_{⁺} concentration was essentially linear according to the relationships/NH₄_{⁺}=144 [¹⁴NH₄_{⁺}]−0.3077 (R²=0.994) and/NH₄_{⁺}=100 [¹⁵NH₄_{⁺}]+0.2745 (R²=0.999).

X-ray Diffraction (XRD) analysis was carried out using a Bruker D8 Advance diffractometer, which operates a Cu K_{α} X-ray source with wavelength of 1.5418 Å. The studied 2θ range was 25°-110°; the scan rate was 0.014° s⁻¹. Rotation at 10 rpm was applied during the measurements. Electrodes after electrochemical tests were disconnected from the cell inside the Ar-filled glovebox, dipped in THF several times to remove the electrolyte residue, and left to dry overnight. The dried electrodes were loaded into a custom-made air-tight dome holder, removed from the glovebox to be transferred to the XRD instrument, and analysed without being contacted with ambient environment at any stage.

Scanning electron microscopic (SEM) and energy dispersive X-ray (EDX) spectroscopic analysis was performed using a JEOL JSM-7001F FEGSEM microscope equipped with a JEOL 50 mm² Si(Li) EDX detector with Gatan EDX DigitalMicrograph plug-in. The instrument was operated at an accelerating voltage of 15 kV and a probe current of 50 pA with a field emission gun. Electrodes were pretreated following the same procedures as for the XRD characterisation, firmly attached to an SEM stub with a conductive double-sided carbon tape, and placed into an air-tight container to be transported to the instrument. However, samples were exposed to ambient environment for a short period of time required to load them into the microscope.

X-ray photoelectron spectroscopic (XPS) analysis was performed using a Nexsa Surface Analysis System, ThermoFisher Scientific instrument with a monochromatic Al K_{α} source (1486.6 eV). X-ray spot size was set to 400 μm. The analysis chamber was maintained at a pressure of 1.0×10⁻⁸ bar or less. Survey scans were recorded at a pass energy of 200 eV and a step size of 1 eV, while high resolution data were obtained at a pass energy of 50 eV and a step size of 0.1 eV. Samples were loaded onto the holder inside the Ar-filled glovebox and left under vacuum in the glovebox antechamber for 10 min before being transported to the instrument without contacting ambient environment at any stage. The samples were kept in ultra-high vacuum overnight before XPS measurements were carried out. No electrical contact between the sample and the instrument ground was present, and the samples were charge neutralised before the analysis. Collected spectral data were energy corrected by adjusting the maximum of the aliphatic C—C peak in C 1s spectra to 284.8 eV.

Viscosity measurements were undertaken with a Lovis 2000M Anton Paar viscosimeter (Lovis angle of 30°) at controlled temperature of 25° C. Each sample was analysed 3 times and the standard deviation was less than 0.001 g cm⁻³ and mPa s.

Conductivity of the electrolyte solutions was measured by electrochemical impedance spectroscopy in a two-electrode (Pt wire) dip cell using a Solartron 1296 dielectric interface connected to a Biologic MTZ-35 frequency response analyser in a frequency range from 10⁷ to 1 Hz at controlled temperature of 25° C. The cell constant measured using a standard 0.01 M KCl_{(aq.)} solution with a recorded conductivity of 1408 μS cm⁻¹ at 25° C. was 1.19 cm⁻¹. Three measurements were applied to each sample with the standard deviation obtained less than 0.001 mS cm⁻¹.

### Example 1. Chronoamperometric (CA) Ammonia Production at Different LiTFSI Concentrations

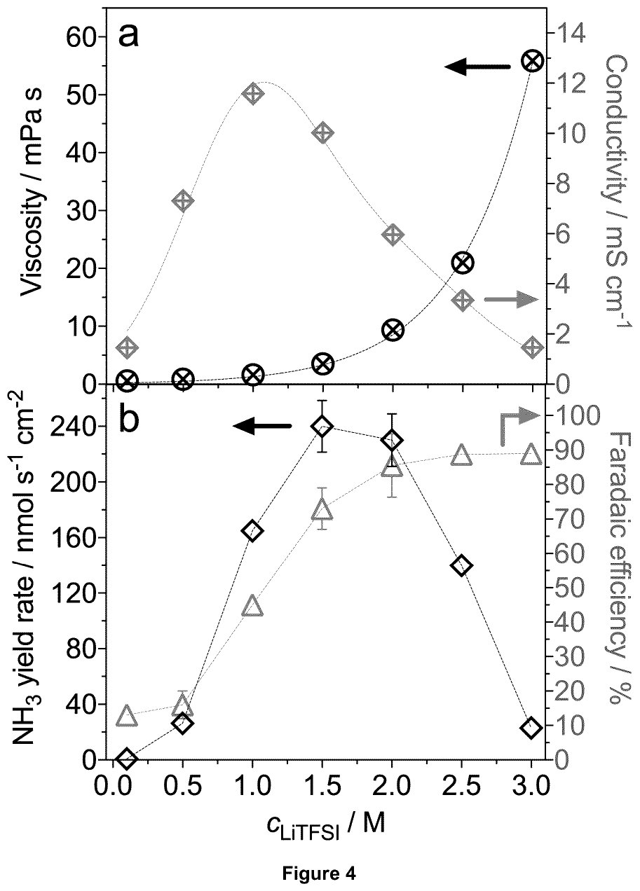

Seven electrolytes comprising lithium bis(trifluoromethanesulfonyl)imide (LiTFSI) and ethanol (EtOH) in tetrahydrofuran (THF) were prepared, with EtOH concentrations of 0.1 M and LiTFSI concentrations of 0.1 M, 0.5 M, 1 M, 1.5 M, 2 M, 2.5 M and 3 M. The ionic conductivity and viscosity of these electrolytes was determined, with the results shown in Table 1 and FIG. 4 (a).

A series of CA experiments were performed using the electrolytes in the single compartment cell with a nickel wire cathode (0.15 cm² surface area) at an applied potential of −0.55 V vs Li/Li⁺. The experiments were conducted for 6 hours under 15 bar of N₂ (static pressure), with the electrolyte stirred at 600 rpm. The results are shown in Table 1 and FIG. 4 (b).

TABLE 1

| | | Conduct- | | Total | Yield | Faradaic |
|---|---|---|---|---|---|---|
| [LiTFSI]/ | Viscosity/ | ivity/ | Charge/ | NH₃/ | rate/nmol | efficiency/ |
| M | mPa s | mS cm⁻¹ | C | μmol | s⁻¹ cm⁻² | % |
| 0.1 | 0.58 | 1.4 | 1.50 | 0.67 | 0.20 | 13 |
| 0.5 | 0.84 | 7.3 | 130 ± 40 ^{a} | 72 ± 9^{a} | 23 ± 2 ^{a} | 17 ± 4 ^{a} |
| 1 | 1.6 | 12 | 345 | 539 | 166 | 45 |
| 1.5 | 3.5 | 10 | 330 ± 50 ^{a} | 800 ± 60 ^{a} | 250 ± 20 ^{a} | 71 ± 6 ^{a} |
| 2 | 9.4 | 6.0 | 260 ± 40 ^{b} | 750 ± 70 ^{b} | 230 ± 20 ^{b} | 86 ± 9 ^{b} |
| 2.5 | 21 | 3.4 | 160 | 457 | 141 | 83 |
| 3 | 56 | 1.5 | 24 | 74 | 23 | 89 |

^{a,b} Mean and standard deviation for n = ^{b} 3 and ^{c} 7 independent repeats of the experiment.

The current flowing through the system was approximately stable over 6 hours, regardless of the lithium salt concentration used. Increasing the LiTFSI concentration from 0.1 to 0.5 M increased the NH₃ yield rate (YR) significantly, to more than 20 nmol s⁻¹ cm⁻², but the faradaic efficiency (FE) for both experiments was within the 10-20% range. Further increases in the LiTFSI concentration to 1 M produced a substantial increase in the YR and FE to 160 nmol s⁻¹ cm⁻² and 45% respectively.

Further increases in the LiTFSI concentration produced more viscous solutions with progressively suppressed ionic conductivity. Surprisingly, this did not immediately deteriorate the NRR performance. In fact, extremely high NH₃ yield rates of 250±20 and 230±20 nmol s⁻¹ cm⁻² were achieved with the 1.5 and 2 M LiTFSI electrolytes respectively, with FE above 80% in the latter case. Decreasing YR was only observed in the highly viscous 2.5 and 3 M solutions where viscosity exceeded 20 mPa s and mass transport became a limiting factor. However, FE remained high in these electrolytes. The results demonstrate that an increase in the LiTFSI salt concentration progressively increases the N₂ reduction faradaic efficiency, which approaches 90% at [LiTFSI]≥2 M.

### Example 2. Chronoamperometric (CA) Ammonia Production with Different Lithium Salts at Low and High Concentrations

The electrochemical nitrogen reduction results obtained with the TFSI anion at low lithium concentrations, as obtained in Example 1, were compared against the results of a CA experiment conducted with the trifluoromethanesulfonate (OTf) anion. The CA experiment was carried out with an electrolyte comprising 0.2 M lithium trifluoromethanesulfonate (LiOTf) and 0.18 M ethanol in THF, in the single compartment cell with a copper wire cathode at an applied potential of −0.55 V vs Li/Li⁺. The experiments were conducted for 12 hours under 15 bar of N₂ (static pressure), with the electrolyte stirred at 600 rpm. The experiment produced a faradaic efficiency of only 7% and a yield rate of only 0.049 nmol s⁻¹ cm⁻², demonstrating the superior performance of the TFSI anion.

The effect of the anion selection was investigated at higher lithium salt concentrations with various weakly coordinating anions, including perchlorate (OCI₄_{^{−}}), tetrafluoroborate (BF₄_{^{−}}), triflate (OTf⁻), bis(fluorosulfonyl)imide (FSI) and bis(trifluoromethanesulfonyl)imide. Electrolytes comprising lithium salts of these coordinating anions and ethanol (EtOH) in tetrahydrofuran (THF) were prepared as shown in Table 2, with EtOH concentrations of 0.1 M and lithium salt concentrations of 2 M. The ionic conductivity and viscosity of these electrolytes was determined, with the results shown in Table 2.

A series of CA experiments was performed using the electrolytes in the single compartment cell with a nickel wire cathode (0.15 cm² surface area) at an applied potential of −0.55 V vs Li/Li⁺. The experiments were conducted for 6 hours under 15 bar of N₂ (static pressure), with the electrolyte stirred at 600 rpm. The dinitrogen reduction results are also shown in Table 2.

TABLE 2

| | | Conduct- | | | Yield | Faradaic |
|---|---|---|---|---|---|---|
| | Viscosity/ | ivity/ | Charge/ | Total NH₃/ | rate/nmol | efficiency/ |
| anion | mPa s | mS cm⁻¹ | C | μmol | s⁻¹ cm⁻² | % |
| OCl₄⁻ | 2.5 | 2.0 | 168 | 63.2 | 20 | 11 |
| BF₄⁻ | 1.9 | 3.8 | 134 | 68.0 | 21 | 15 |
| BF₄⁻ | 1.9 | 3.8 | 140 | 51.0 | 16 | 11 |
| OTf⁻ | 2.7 | 1.3 | 268 | 32.4 | 10 | 33 |
| BF₄⁻ + | 4.4 | 7.9 | 224 | 305 | 94 | 39 |
| TFSI⁻ | | | | | | |
| (1:1) | | | | | | |
| TFSI⁻ | 9.4 | 6.0 | 260 ± 40 ^{b} | 750 ± 70 ^{b} | 230 ± 20 ^{b} | 86 ± 9 ^{b} |
| FSI⁻ | 5.4 | 14 | 606 | 823 | 254 | 47 |

^{b} Mean and standard deviation for n = 7 independent repeats of the experiment.

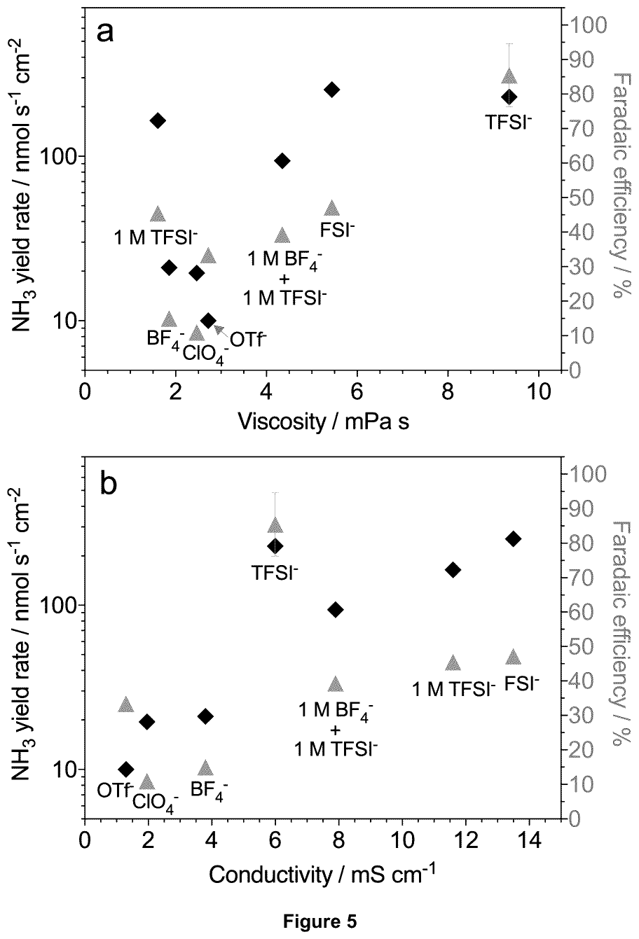

The dinitrogen reduction results (also including the 1M LiTFSI result from Example 1) are compared in FIG. 5, with the electrolytes arranged based on either viscosity or ionic conductivity. The viscosity of the solutions increased in the order BF₄_{^{−}}<ClO₄_{^{−}}<OTf⁻<FSI⁻<TFSI and the conductivity increased in the order OTf⁻<ClO₄_{^{−}}; <BF₄_{^{−}}<TFSI<FSI⁻. The NH₃ yield rate and faradaic efficiency correlate to a degree with the ionic conductivity (FIG. 5 b). However, the 2 M LiTFSI and 2 M LiFSI electrolytes both provided outstandingly high yield rates (with TFSI similar to FSI) and faradaic efficiencies (with TFSI superior to FSI) despite the significant difference in ionic conductivity. Moreover, the electrolyte containing 1 M LiTFSI provides improved results compared to other lithium salts (LiBF₄, LiOCl4, LiOTF) despite the lower conductivity. The fluorinated sulfonyl imide anions (e.g. TFSI and FSI) thus provide a clear advantage over other weakly coordinating anions, independent of the effects of ionic conductivity or viscosity.

The electrolyte containing 1 M LiTFSI and 1 M LiBF₄ (2 M total Li⁺) combination also provided excellent dinitrogen reduction performance, but at a lower yield rate than with electrolytes containing 2 M LiTFSI or 1 M LiTFSI. This demonstrates an improved result when a fluorinated sulfonyl imide is the only weakly coordinating anion present, independent of the lithium concentration.

### Example 3. Chronoamperometric (CA) Ammonia Production with Different Cathode Materials

The effect of the cathode composition was investigated using various different metals, as shown in Table 3, as the working electrode in an electrochemical cell. CA experiments were performed using electrolytes comprising LiTFSI (2 M) and EtOH (0.18 M or 0.10 M) in THF in the single compartment cell at an applied potential of −0.55 V vs Li/Li⁺. The experiments were conducted for 6 hours under 15 bar of N₂ (static pressure), with the electrolyte stirred at 600 rpm. The results are shown in Table 3.

TABLE 3

| | Electrode | Pre- | | NH₃ yield | Faradaic | Energy |
|---|---|---|---|---|---|---|
| Working | area/ | treatment | ethanol | rate/nmol | efficiency/ | efficiency/ |
| electrode | cm² | method | conc. | s⁻¹ cm⁻² | % | % |
| Copper | 0.62 | Electro- | 0.18 | 18 | 44 | 7.9 |
| wire | | polishing | | | | |
| Copper foil | 0.74 | Electro- | 0.18 | 65 | 44 | 7.7 |
| | | polishing | | | | |
| Niobium | 0.44 | Nil | 0.18 | 80 ± 6 | 55 ± 5 | 9.7 ± 0.9 |
| foil | | | | | | |
| Nickel wire | 0.15 | Electro- | 0.18 | 131 ± 20 | 81 ± 9 | 15 ± 2 |
| | | polishing | | | | |
| Nickel wire | 0.15 | Electro- | 0.10 | 230 ± 20 | 86 ± 9 | 15 ± 2 |
| | | polishing | | | | |

All cathode materials provided good ammonia synthesis performance, although the chemical nature of the cathode does affect the reaction kinetics with faradaic efficiency and NH₃ yield rate increasing in the order Cu<Nb<Ni. Without wishing to be limited by any theory, it is proposed that the cathode composition may play a secondary role in establishing a desirable electrode-electrolyte interfacial layer at the cathode surface in the Li-mediated NRR process.

### Example 4. Characterisation of Post-Reaction Cathodes

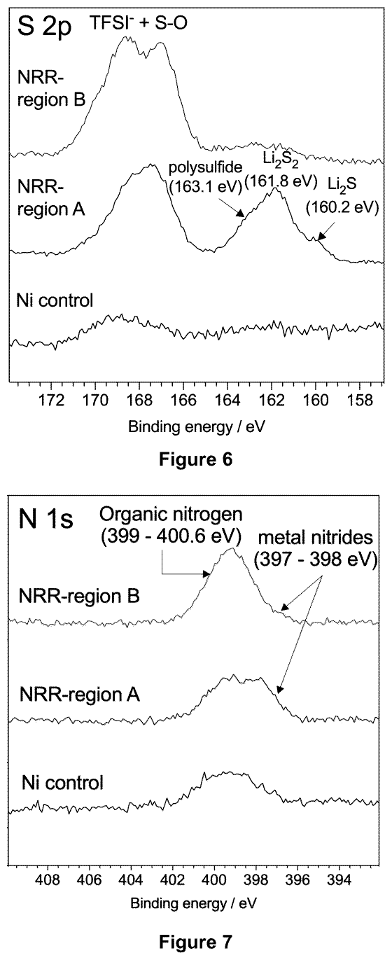

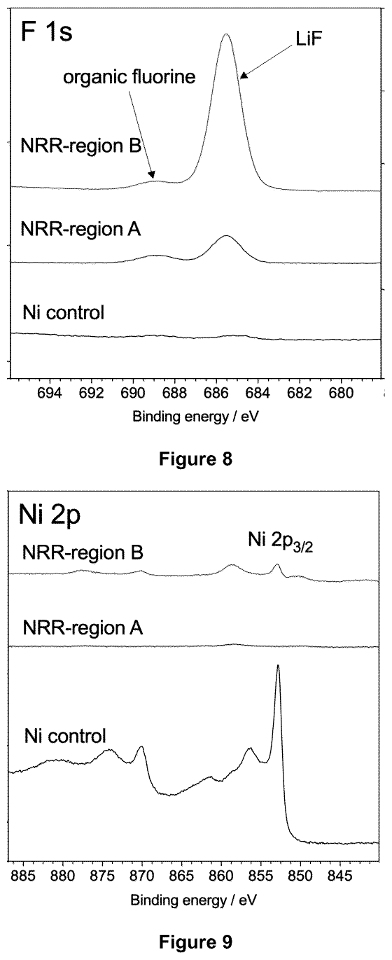

Nickel wire cathodes used in dinitrogen reduction reactions with different electrolytes were analysed post-reaction. A cathode used in an electrolyte containing 2 M LiTFSI and 0.1 M EtOH in THF (Example 1) was visually clean in the portion of wire fully submerged in the electrolyte (region B), but visible deposits were apparent along the wire portion near the stirred electrolyte surface (region A) where electrochemical reactions occurred at a static gas-electrolyte meniscus (cathode/electrolyte/gas phase). Regions A and B were characterised by electron microscopy and XPS. Selected XPS spectra are shown in FIG. 6 (S 2p), FIG. 7 (N 1s), FIG. 8 (F 1s) and FIG. 9 (Ni 2p).

The major components of the region A deposits were identified as LiF (see FIG. 8), Li₃N (see FIG. 7), and sulphur-based compounds including lithium sulphide and polysulfide (see FIG. 6). In contrast, characterisation of the region B cathode portion indicated the presence only of a very thin, coherent layer of electrolyte (including intact TFSI anion), solid LiF and S—O species (see FIG. 8). The thickness of this solid interfacial layer is not more than 10 nm since a clear Ni 2p signal could be detected by XPS, in contrast to region A (see FIG. 9).

Without wishing to be bound by any theory, it is proposed that the formation of deposits on region A is at least partially associated with the very high concentration gradient of N₂ and depletion of ethanol proton carrier across the gas-solution phase boundary, which induces excessively high rates of the Li₃N formation on the cathode near the triple-phase interface. This promotes excessive Li⁰ deposition and uncontrollable electroreductive transformations of the electrolyte. It is expected that formation of deposits at the electrode-electrolyte-gas triple phase boundary consumes a significant portion of charge, thereby decreasing the faradaic efficiency, and inhibits mass transfer to the cathode, thereby contributing to instability of the reaction system over time.

A cathode used in an electrolyte containing 0.5 M LiTFSI and 0.1 M EtOH in THF (Example 1) was covered with visible grey deposits after the reaction, including in the cathode portion fully submerged in the electrolyte. The major Li-based component of the deposit was identified by XPS as LiF, which had electrodeposited uncontrollably during the experiment.

Substantially more electrolyte decomposition thus occurred on the cathode used in 0.5 M LiTFSI electrolyte than in 2 M LiTFSI electrolyte. It is proposed that a higher concentration of lithium fluorinated sulfonyl imide salts (e.g. LiTFSI) in the electrolyte facilitates the formation of a protective ionic assembly, comprising bulky and electrochemically stable anions and Li cations, in an electrolyte-electrode interface layer at the cathode surface. This electrolyte-electrode interface suppresses the decomposition of electrolyte while still permitting high rates of dinitrogen reduction. As a result, highly productive and selective reduction of dinitrogen to ammonia can be obtained and sustained for long reaction times on the cathode.

A cathode used in an electrolyte containing 2 M LiBF₄ and 0.1 M EtOH in THF (Example 1) was covered with a thick grey deposit after the reaction, including in the cathode portion fully submerged in the electrolyte. The major Li-based component of the deposit was again LiF. Without wishing to be bound by any theory, this experiment highlights (i) the superior capability of lithium fluorinated sulfonyl imide salts (e.g. LiTFSI) to form a protective electrolyte-electrode interface, compared to other lithium salts of weakly coordinating anions and/or (ii) the superior electrochemical stability of the fluorinated sulfonyl imide anion.

### Example 5. Chronoamperometric (CA) Ammonia Production without a Static Gas-Electrolyte Meniscus at the Cathode

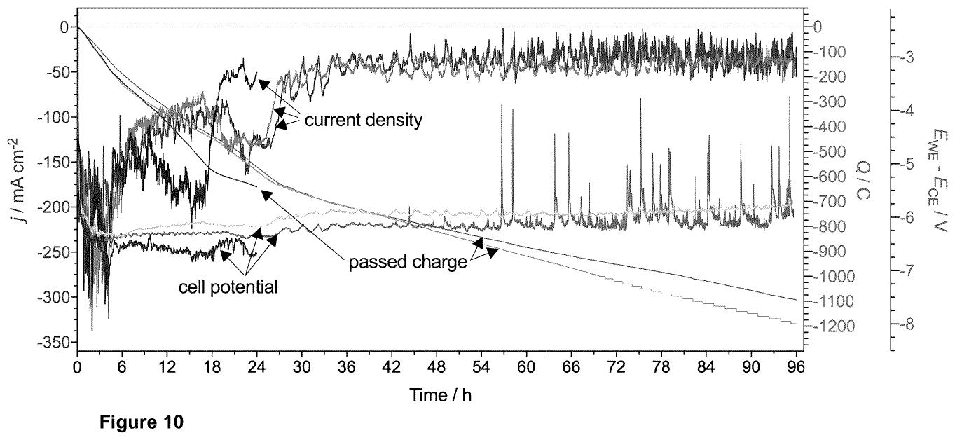

Longer duration CA experiments were performed using electrolyte comprising LiTFSI (2 M) and EtOH (0.10 M) in THF in the single compartment cell with an isolated nickel wire cathode (0.05 cm² surface area) at an applied potential of −0.55 V vs Li/Li⁺. The nickel wire was sealed in glass except for the 3 mm end portion, so that the entire exposed nickel surface area was fully submerged in the electrolyte during the reaction (i.e. no static gas-electrolyte meniscus). The experiments were conducted for 24 or 96 hours under 15 bar of N₂ (static pressure), with the electrolyte stirred at 600 rpm. The results are shown in Table 4 and FIG. 10, which shows the evolution of current density, charge passed and overall cell potential over time.

TABLE 4

| | | Total NH₃/ | Yield rate/ | Faradaic |
|---|---|---|---|---|
| Time/h | Charge/C | μmol | nmol s⁻¹ cm⁻² | efficiency/% |
| 24 | 641 | 2164 | 500 | 98 |
| 96 | 1189 | 4057 | 234 | 99 |
| 96 | 1094 | 3749 | 216 | 99 |

With the new cathode configuration, the nitrogen reduction reaction was performed with a faradaic efficiency of 99±1% (Table 4). During the initial activation period of about 24 h, the average ammonia yield rate was about 500 nmol s⁻¹ cm⁻². After this period, the system stabilised and provided stable performance over 96 h with an average ammonia yield rate of 170-200 nmol s⁻¹ cm−2.

At the end of the reactions, the cathodes were visually clean. The improved faradaic efficiency in these experiments (as compared to earlier examples using the same electrolyte) is ascribed to the elimination of the triple phase boundary at the electrolyte surface area. With the cathode only exposed to dinitrogen dissolved in the electrolyte, the electrochemically-induced electrolyte decomposition reactions were substantially suppressed.

The results demonstrate that electrochemical reduction of dinitrogen to ammonia may be performed with near-quantitative selectivity and high rates, sustained over long reaction times, when using an electrolyte comprising a lithium salt with a fluorinated sulfonyl imide anion at high lithium concentrations.

### Example 6. Potential Dependence

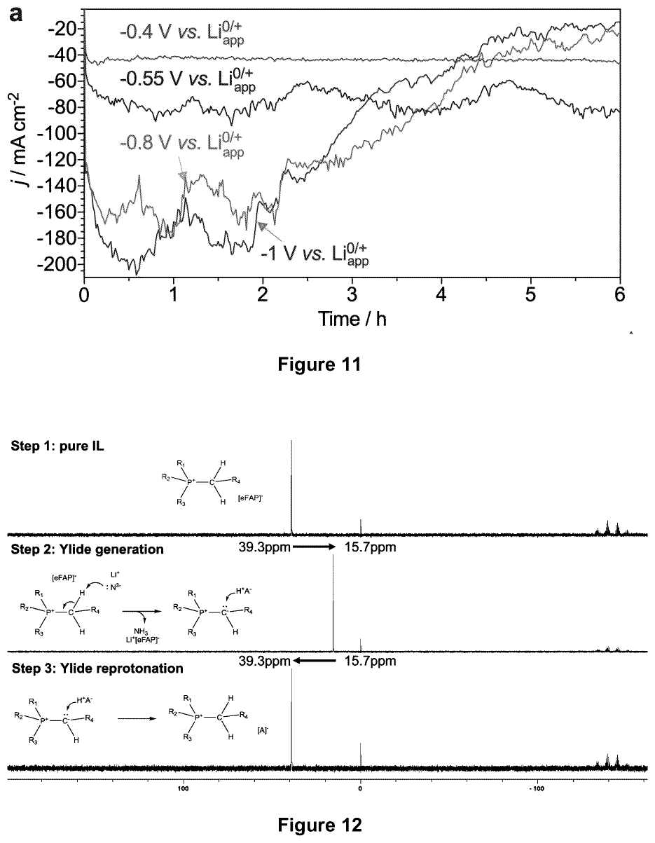

The effect of the reduction potential was investigated in a series of CA experiments performed using electrolyte comprising LiTFSI (2 M) and EtOH (0.10 M) in THF in the single compartment cell with a nickel wire cathode (0.15 cm² surface area). The experiments were conducted for 6 hours under 15 bar of N₂ (static pressure), with the electrolyte stirred at 600 rpm. Potentials in the range of −0.2 to −1 V relative to Li/Li⁺ were investigated, and the results are shown in Table 5 and FIG. 11.

TABLE 5

| | | Total NH₃/ | Yield rate/ | Faradaic |
|---|---|---|---|---|
| E/V vs Li/Li⁺ | Charge/C | μmol | nmol s⁻¹ cm⁻² | efficiency/% |
| −0.20 | 70 | 126 | 39 | 52 |
| −0.40 | 141 | 315 | 97 | 65 |
| −0.45 | 173 | 385 | 119 | 65 |
| −0.50 | 220 ± 20 ^{b} | 630 ± 20 ^{b} | 195 ± 8 ^{b} | 85 ± 12 ^{b} |
| −0.55 | 260 ± 40 ^{c} | 750 ± 70 ^{c} | 230 ± 20 ^{c} | 86 ± 9 ^{c} |
| −0.60 | 290 ± 20 ^{b} | 810 ± 50 ^{b} | 250 ± 14 ^{b} | 82 ± 9 ^{b} |
| −0.70 | 320 ± 20 ^{b} | 895 ± 7 ^{b} | 276 ± 2 ^{b} | 82 ± 7 ^{b} |
| −0.80 | 365 ± 4 ^{b} | 1140 ± 90 ^{b} | 310 ± 60 ^{b} | 82 ± 12 ^{b} |
| −1.00 | 326 | 824 | 254 | 73 |
| −1.00 | 319 | 798 | 246 | 72 |

^{b, c} Mean and standard deviation for n = ^{b} 3 and ^{c} 7 independent repeats of the experiment.

Moving towards increasingly negative potentials, from −0.2 V to −0.8 V vs Li/Li⁺, increased both the reduction rate (FIG. 11) and the ammonia yield rate (Table 8). Faradaic efficiency in excess of 80% was maintained in the −0.50 to −0.80 V vs Li/Li⁺ range. However, the performance deteriorated after several hours of operation at −0.7, −0.8 and −1.0 V vs Li/Li⁺ (FIG. 11).

After the reaction at −1.0 V vs Li/Li⁺, the nickel cathode was covered with substantial amounts of visible deposits, including in the cathode portion fully submerged in the electrolyte. The major Li-based component of the deposits was identified by XPS as LiF, which had electrodeposited uncontrollably at the very negative potentials of the experiment. Analysis by X-ray diffraction (XRD) revealed a set of peaks associated with lithium amide, oxide, sulphide and fluoride, the latter two being products of electrolyte anion decomposition. The deterioration in reduction performance with time is ascribed to the build-up of these decomposition products on the cathode surface.

### Example 7. Pressure Dependence

The effect of dinitrogen pressure was investigated in a series of CA experiments performed using electrolyte comprising LiTFSI (2 M) and EtOH (0.10 M) in THF in the single compartment cell with a nickel wire cathode (0.15 cm² surface area) at an applied potential of −0.55 V vs Li/Li⁺. The experiments were conducted for 6 hours under 15 bar of N₂ (static pressure), with the electrolyte stirred at 600 rpm. Pressures in the range of 1 bar to 20 bar were investigated, and the results are shown in Table 6.

TABLE 6

| N₂ pressure/ | | Total NH₃/ | Yield rate/ | Faradaic |
|---|---|---|---|---|
| bar | Charge/C | μmol | nmol s⁻¹ cm⁻² | efficiency/% |
| 1 | 118 | 65 | 20 | 16 |
| 5 | 202 | 466 | 144 | 67 |
| 10 | 280 ± 20 ^{b} | 740 ± 30 ^{b} | 227 ± 9 ^{b} | 76 ± 3 ^{b} |
| 15 | 260 ± 40 ^{c} | 750 ± 70 ^{c} | 230 ± 20 ^{c} | 86 ± 9 ^{c} |
| 20 | 220 ± 20 ^{b} | 680 ± 80 ^{b} | 210 ± 30 ^{b} | 91 ± 8 ^{b} |

^{b, c} Mean and standard deviation for n = ^{b} 3 and ^{c} 7 independent repeats of the
experiment.

During the course of the experiments, relatively stable current densities were recorded in all cases, except for P_{N}_{₂}=20 bar where the electroreduction rate degraded after about 4 h. The latter result was ascribed to the accumulation of excessive Li₃N on the cathode surface. The yield rate and faradaic efficiency were both positively correlated with the dinitrogen pressure over the six hour experiments.

### Example 8. Different Proton Carriers and Proton Carrier Concentrations

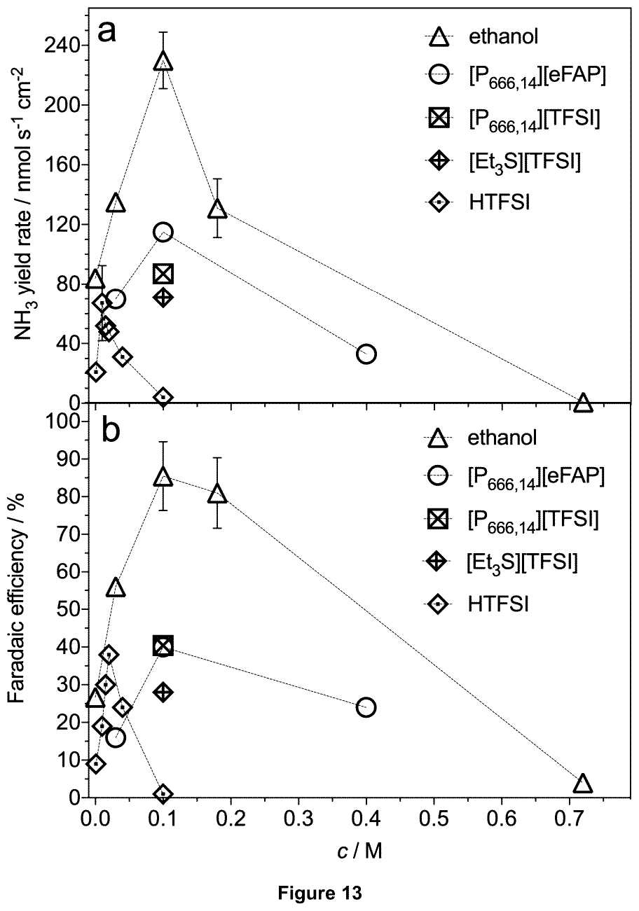

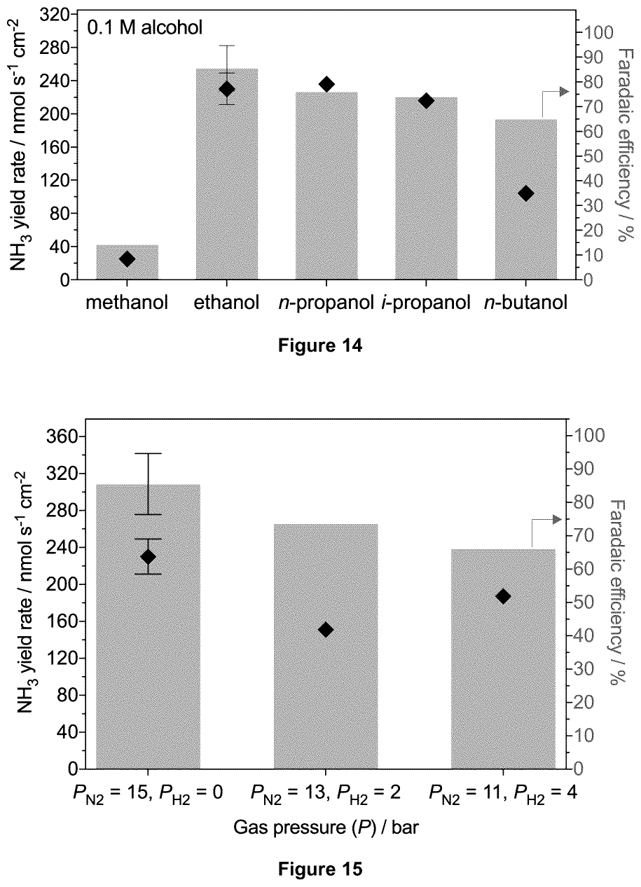

The use of different proton carriers at different concentrations was investigated in a series of CA experiments performed using electrolyte comprising LiTFSI (2 M) in THF in the single compartment cell with a nickel wire cathode (0.15 cm² surface area) at an applied potential of −0.55 V vs Li/Li⁺. The experiments were conducted for 6 hours, with the electrolyte stirred at 600 rpm. The results are listed in Table 8 and summarised in FIGS. 13 and 14.

TABLE 8

| | Proton | | | | |
|---|---|---|---|---|---|
| | carrier | | Total NH₃/ | Yield rate/ | Faradaic |
| Proton carrier | conc./M | Charge/C | μmol | nmol s⁻¹ cm⁻² | efficiency/% |
| Tetrahydrofuran^{a} | 8.9 | 291 | 272 | 84 | 27 |
| Methanol | 0.1 | 164 | 81 | 25 | 14 |
| Ethanol | 0.03 | 777 | 436 | 135 | 56 |
| | 0.1 | 260 ± 40 ^{b} | 750 ± 70 ^{b} | 230 ± 20 ^{b} | 86 ± 9 ^{b} |
| | 0.18 | 150 ± 40 ^{c} | 420 ± 70 ^{c} | 130 ± 20 ^{c} | 81 ± 9 ^{c} |
| | 0.72 | 19 | 2.6 | 0.8 | 4 |
| n-propanol | 0.1 | 292 | 765 | 236 | 76 |
| i-propanol | 0.1 | 274 | 701 | 216 | 74 |
| n-butanol | 0.1 | 150 | 337 | 104 | 65 |
| [P_{666, 14}][TFSI] | 0.03 | 355 | 198 | 70 | 16 |
| | 0.1 | 315 | 436 | 115 | 40 |
| | 0.4 | 110 | 93 | 33 | 24 |
| [P_{666, 14}][eFAP] | 0.1 | 201 | 280 | 87 | 40 |
| [Et₃S][TFSI] | 0.1 | 243 | 230 | 71 | 30 |
| HTFSI^{d} | 0.001 | 237 | 70 | 21 | 9 |
| | 0.01 | 300 ± 100 ^{c} | 220 ± 80 ^{c} | 70 ± 30 ^{c} | 19 ± 1 ^{c} |
| | 0.015 | 163 | 168 | 52 | 30 |
| | 0.02 | 119 | 157 | 48 | 38 |
| | 0.04 | 121 | 99 | 31 | 24 |
| | 0.1 | 391 | 14 | 4 | 1 |

^{a} No proton carrier was added.
^{b-c} Mean and standard deviation for n = ^{b} 7 and ^{c} 3 independent repeats of the experiment.
HTFSI = bis(trifluoromethanesulfonyl)amine; (CF₃SO₂)₂NH.

Various different classes of proton carrier were thus shown to be effective: including (i) neutral proton carriers including alcohols such as methanol, ethanol, n-propanol, isopropanol and n-butanol), the Bronsted acid bis(trifluoromethanesulfonyl)amine and THF itself (an ether), and (ii) cationic proton carriers such as phosphonium salts. FIG. 13 plots the yield rate and faradaic efficiency results for different types of proton carriers, showing that the optimum concentration may be different for different classes of proton carrier. The best results were obtained with alcohols. FIG. 14 compares the yield rates and faradaic efficiencies obtained with different alcohols, all at the 0.1 M concentration found to be optimum for ethanol. Excellent results were obtained with all of the C₂-C₄ alcohols.

### Example 9. Ylide Regeneration Investigations

To investigate the role of alkyl phosphonium species as a regenerable proton carrier during the electrochemical Li-mediated ammonia synthesis, a series of experiments were performed with [P_{666,14}][eFAP] and monitored by ³¹P NMR spectroscopy as depicted in FIG. 12. All reactions were carried out using dried materials in inert atmosphere in the argon glovebox (O₂ and H₂O<0.5 ppm). ³¹P-NMR spectra were recorded in THF, using external capillary with PPhs as a reference, according to which axis was calibrated at 0 ppm.

In the first step, a 0.2 M solution of [P_{666,14}][eFAP] in THF was prepared and the ³¹P NMR spectrum was recorded. As seen in FIG. 12, the spectrum features one ³¹P NMR signal corresponding to the phosphonium cation [P_{666,14}] at 39.3 ppm and a group of signals between −131 and −151 ppm corresponding to the [eFAP] anion. In the second step an excess of Li₃N was added to the 0.2 M solution of [P_{666,14}][eFAP] and the mixture was stirred for 24 h. Visually, no changes of the mixture were observed: it remained colourless, transparent and without any visible precipitates. The ³¹P NMR spectrum recorded after 24 hours (middle spectrum in FIG. 12) shows that the peak at 39.3 ppm had fully disappeared and a new peak appeared at 15.7 ppm. This peak corresponds to a zwitterionic species formed in near-quantitative yield via deprotonation of the phosphonium cation by reaction with Li₃N. The NMR data is consistent with the formation of a phosphonium ylide. In the third step, 0.2 ml of a 0.1 M solution of acetic acid was added to 0.5 ml of the ylide-containing solution and the ³¹P NMR spectrum was recorded (bottom spectrum in FIG. 12). The spectrum shows quantitative recovery of the phosphonium cation (peak at 39.3 ppm).

The recovery of the phosphonium cation was confirmed using mass spectroscopy (MS): the mass spectra from stage 1 and stage 3 were identical, showing only one signal (m/z=483) corresponding to the [P_{666,14}] cation.

This stepwise reaction process was repeated for other phosphonium salts as follows: [P₁₂₂₂][eFAP], [P₄₄₄₈][eFAP] and triphenylmethyl phosphonium tetrafluoroborate ([PPh₃Me][BF₄]). All ³¹P-NMR spectra showed generation of the ylide species when reacted with Li₃N and then regeneration of the phosphonium cation after the addition of acetic acid. This demonstrates that a range of alkyl phosphonium cations are suitable cationic proton carriers, and that the stepwise reaction test can be used as a screening method for potential proton carriers.

### Example 10. H₂ as Anodic Proton Source

Experiments as per Example 1 (electrolyte: 2 M LiTFSI, 0.1 M EtOH in THF) were carried out including 2 or 4 bar dihydrogen (H₂) mixed into the N₂ gas supply at total pressure of 15 bar. The results are shown in FIG. 15, indicating that high yield rate and faradaic efficiency is maintained in the presence of H₂.

### Example 11. Ionic Liquid Additives

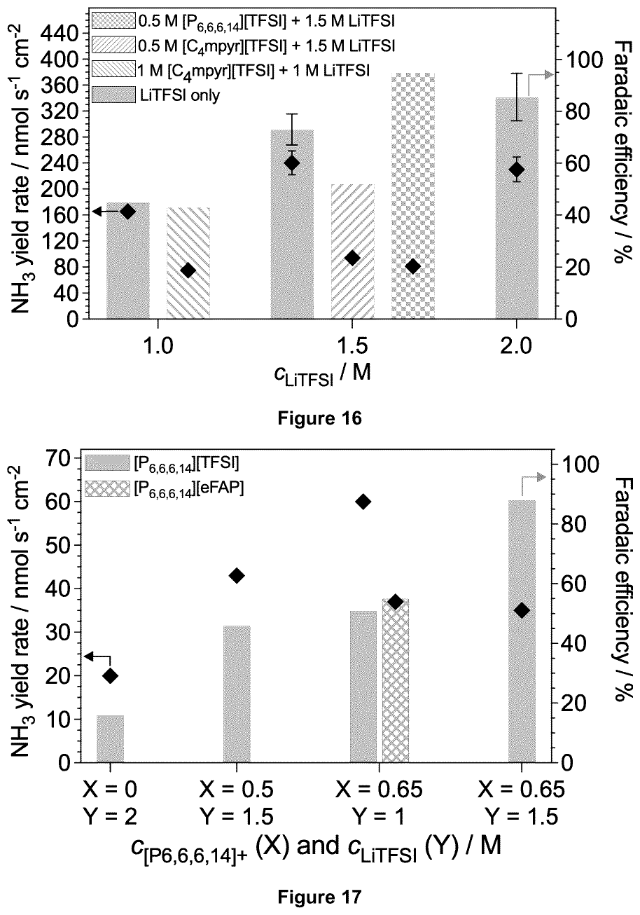

CA experiments were performed using electrolyte comprising LiTFSI (1M, 1.5M or 2 M), EtOH (0.10 M) and different quantities of ionic liquid additives in THF, in the single compartment cell with a non-isolated nickel wire cathode (0.15 cm² surface area; as used in Example 1) at an applied potential of −0.55 V vs Li/Li⁺. The experiments were conducted for 6 hours at room temperature under 15 bar of N₂ (static pressure), with the electrolyte stirred at 600 rpm. The results are shown in FIG. 16 and Table 9.

TABLE 9

| | Ionic | | | | | |
|---|---|---|---|---|---|---|
| | liquid | LiTFSI | | | | |
| | conc./ | conc./ | | Total NH₃/ | Yield rate/ | Faradaic |
| Ionic liquid | M | M | Charge/C | μmol | nmol s⁻¹ cm⁻² | efficiency/% |
| No additive | 0 | 1 | 345 | 539 | 166 | 45 |
| | | 1.5 | 330 + 50 ^{a} | 800 + 60 ^{a} | 250 + 20 ^{a} | 71 + 6 ^{a} |
| | | 2 | 260 + 40 ^{b} | 750 + 70 ^{b} | 230 + 20 ^{b} | 86 + 9 ^{b} |
| [C₄mpyr][TFSI] | 0.5 | 1.5 | 171 | 305 | 94 | 52 |
| | 1 | 1 | 163 | 243 | 75 | 43 |
| [P_{6, 6, 6, 14}][TFSI] | 0.5 | 1.5 | 80 | 261 | 81 | 95 |

^{a, b} Mean and standard deviation for n = ^{a} 3 and ^{b} 7 independent repeats of the experiment.

The extremely high faradaic efficiencies and yield rates at lithium concentrations above 1M, and the increase in faradaic efficiency when increasing the lithium concentration from 1M to 2M, is again evident in the experiments without ionic liquid additive. The presence of 1-butyl-1-methylpyrrolidinium bis-(trifluoromethylsulfonyl)imide ([C₄mpyr][TFSI]) as an ionic liquid additive (0.5M or 1M, to provide a constant 2M total salt concentration in the electrolyte) was found to be detrimental to both the faradaic efficiency and the yield rate. By contrast, the presence of trihexyl(tetradecyl) phosphonium bis-(trifluoromethylsulfonyl)imide; ([P_{6,6,6,14}][TFSI]) as an ionic liquid additive (0.5M, to provide a constant 2M total salt concentration in the electrolyte) enhanced the faradaic efficiency (albeit at lower yield rate).

The results indicate that pyrrolidinium (and even less electrochemically stable non-metal cations such as imidazolium) should preferably be avoided, whereas phosphonium cations can be tolerated or are even beneficial. Without limitation by theory, it is proposed that tetraalkylphosphonium cations are either unreactive (when ethanol is present as proton carrier) or react reversibly to form a phosphonium ylide proton acceptor under the reduction conditions, such that harmful decomposition reactions are avoided.

### Example 12. Phosphonium Ionic Liquid Additives at Low N₂ Pressure

CA experiments were performed using electrolyte comprising LiTFSI (1 to 2 M), EtOH (0.10 M) and different quantities of ([P_{6,6,6,14}][TFSI] additive in THF, in the single compartment cell with an isolated nickel wire cathode (0.05 cm² surface area) at an applied potential of −0.55 V vs Li/Li⁺. The nickel wire was sealed in glass except for the 3 mm end portion, so that the entire exposed nickel surface area was fully submerged in the electrolyte during the reaction (i.e. no static gas-electrolyte meniscus). The experiments were conducted for 6 hours at room temperature under 1 bar of N₂ (static pressure), with the electrolyte stirred at 600 rpm. The results are shown in FIG. 17 and Table 10.

TABLE 10

| | Ionic | | | | Yield | |
|---|---|---|---|---|---|---|
| | liquid | LiTFSI | | Total | rate/ | Faradaic |
| | conc./ | conc./ | Charge/ | NH3/ | nmol s⁻¹ | efficiency/ |
| Ionic liquid | M | M | C | umol | cm⁻² | % |
| [P_{6,6,6,14}] | 0 | 2 | 118 | 65 | 20 | 16 |
| [TFSI] | 0.5 | 1.5 | 87 | 138 | 42 | 46 |
| | 0.65 | 1 | 37 | 65 | 60 | 51 |
| | 0.65 | 1.5 | 12 | 37 | 34 | 88 |
| [P_{6,6,6,14}] | 0.65 | 1 | 21 | 40 | 36 | 55 |
| [eFAP] | | | | | | |

With 2M LiTFSI and no phosphonium ionic liquid additive, the faradaic efficiency was only 16%, due to the low N₂ pressure (1 bar); c.f. Example 17. By replacing a portion of the LiTFSI with [P_{6,6,6,14}][TFSI] (maintaining a constant 2M total salt concentration in the electrolyte, and a Lit concentration of 1.5M), the faradaic efficiency was increased to about 50%, with significant increase in yield rate as well. Increasing the amount of [P_{6,6,6,14}][TFSI] to 0.65M (Li⁺ still 1.5M) produced a significant further increase in faradaic efficiency, to close to 90%. This faradaic efficiency is similar to that obtained in the absence of the ionic liquid additive at high N₂ pressures (c.f. Example 7). Reducing the Lit concentration to 1M, while maintaining a concentration of 0.65M phosphonium ionic liquid (either [P_{6,6,6,14}][TFSI] or [P_{6,6,6,14}][eFAP]) caused a reduction in the faradaic efficiency at 1 bar.

Without wishing to be limited by any theory, it is believed that the phosphonium based ionic liquid increases N₂ solubility in the electrolyte, while maintaining a high ionic concentration and conductivity of the electrolyte, thus favouring the NRR rate and selectivity.

### Example 13. Phosphonium Ionic Liquid Additives at High N₂ Pressure

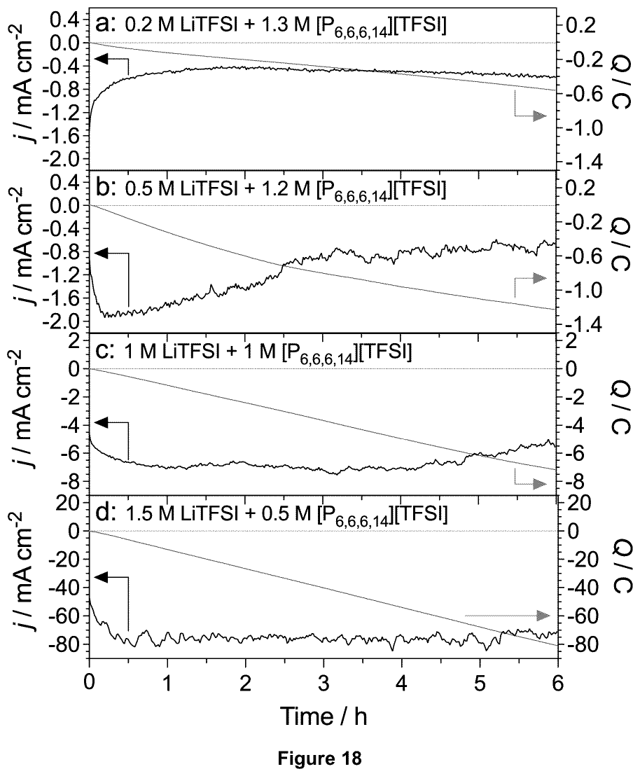

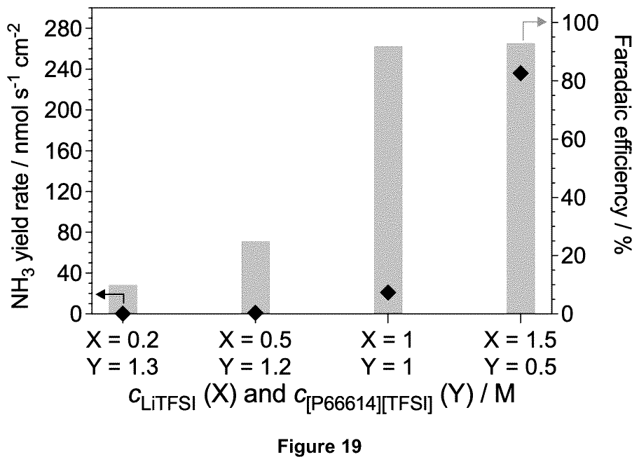

CA experiments were performed using electrolyte comprising LiTFSI (0.2 to 1.5 M), EtOH (0.10 M) and different quantities of [P_{6,6,6,14}][TFSI] additive in THF, in the single compartment cell with an isolated nickel wire cathode (0.05 cm² surface area) at an applied potential of −0.55 V vs Li/Li⁺. The nickel wire was sealed in glass except for the 3 mm end portion, so that the entire exposed nickel surface area was fully submerged in the electrolyte during the reaction (i.e. no static gas-electrolyte meniscus). The experiments were conducted for 6 hours at room temperature under 15 bar of N₂ (static pressure), with the electrolyte stirred at 600 rpm. The results are shown in FIGS. 18-19 and Table 11.

TABLE 11

| [P_{6, 6, 6, 14}][TFSI] | LiTFSI | | Total NH₃/ | Yield rate/ | Faradaic |
|---|---|---|---|---|---|
| conc./M | conc./M | Charge/C | μmol | nmol s⁻¹ cm⁻² | efficiency/% |
| 1.3 | 0.2 | 0.6 | 0.2 | 0.2 | 10 |
| 1.2 | 0.5 | 1.2 | 1 | 1 | 25 |
| 1 | 1 | 7 | 22 | 21 | 92 |
| 0.5 | 1.5 | 80 | 255 | 237 | 93 |

The results again demonstrate the surprising effects of increasing lithium concentration on the faradaic efficiency of nitrogen reduction. At 0.2 M [Li⁺], the faradaic efficiency was only about 10%, despite the presence of [P_{6,6,6,14}][TFSI] ionic liquid additive and thus a high ionic concentration in the electrolyte (1.5 M combined lithium and phosphonium cation; 1.5 M TFSI anion). At 0.5 M [Li⁺] and total ionic concentration of 1.7 M, the faradaic efficiency had increased significantly (c.a. 25%). At 1 M [Li⁺], with total ionic concentration of 2 M, the faradaic efficiency was over 90%. The addition of [P_{6,6,6,14}][TFSI] in this case allowed the faradaic efficiency to match that obtained at 1.5 M [Li⁺] alone, albeit at a lower yield rate (c.f. results without phosphonium cation in Table 1).

### Example 14. Fluorinated Sulfonyl Methide Anions

CA experiments were performed using electrolyte comprising lithium tris(trifluoromethanesulfonyl) methide [Li(CF₃SO₂)₃C; ≥99%; FUJIFILM Wako Pure Chemical Corporation] (1.1M) and EtOH (0.10 M) in THE, in the single compartment cell with an isolated nickel wire cathode (0.05 cm² surface area) at an applied potential of −0.55 V vs Li/Li⁺. The nickel wire was sealed in glass except for the 3 mm end portion, so that the entire exposed nickel surface area was fully submerged in the electrolyte during the reaction (i.e. no static gas-electrolyte meniscus). The experiments were conducted for 6 hours at room temperature under 15 bar of N₂ (static pressure), with the electrolyte stirred at 600 rpm. The ammonia yield rate was 301 nmol/s/cm² at 70% Faradaic efficiency.

Those skilled in the art will appreciate that the invention described herein is susceptible to variations and modifications other than those specifically described. It is understood that the invention includes all such variations and modifications which fall within the spirit and scope of the present invention.

1. A method of reducing dinitrogen to produce ammonia, the method comprising:
contacting a cathode of an electrochemical cell with an electrolyte comprising:
(i) a metal cation selected from the group consisting of lithium, magnesium, calcium, strontium, barium, zinc, aluminium, vanadium and combinations thereof, wherein the metal cation is present at a concentration of greater than 0.5 mol/L in the electrolyte,
(ii) one or more anions comprising at least one negative ion selected from the group consisting of fluorinated sulfonyl imides, fluorinated sulfonyl methides and combinations thereof,
(iii) a proton carrier; and
(iv) optionally, at least one phosphonium cation,
wherein the combined amount of the metal cation and the optional at least one phosphonium cation is greater than 1 mol/L in the electrolyte;
supplying dinitrogen to the electrochemical cell for cathodic reduction; and
applying a potential at the cathode sufficient to reduce the dinitrogen, thereby producing ammonia.

2. The method according to claim 1, wherein the metal cation is present at a concentration of greater than 1 mol/L in the electrolyte.

3. The method according to claim 1, wherein the metal cation is present at a concentration of greater than 1.5 mol/L in the electrolyte.

4. The method according to claim 1, wherein the at least one negative ion is selected from the group consisting of fluorinated sulfonyl imides, wherein the fluorinated sulfonyl imides have a structure according to Formula 1: 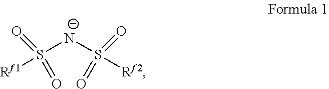
wherein R^{f1} and R^{f2} are independently selected from the group consisting of —F, C₁-C₁₂ perfluoroalkyl and fluoroaryl, or wherein R^{f1} and R^{f2} are connected to form a perfluoroalkylene linker.

5. The method according to claim 1, wherein the at least one negative ion is selected from the group consisting of bis(trifluoromethanesulfonyl)imide (TFSI), bis(fluorosulfonyl)imide (FSI), (trifluoromethanesulfonyl)-(fluorosulfonyl)-imide (FTFSI), tris(trifluoromethanesulfonyl) methide, and combinations thereof.

6. The method according to claim 1, wherein the at least one negative ion is present at a concentration of greater than 1 mol/L in the electrolyte.

7. The method according to claim 1, wherein the at least one negative ion comprises at least 80 mol % of the one or more anions.

8. The method according to claim 1, wherein the metal cation is lithium.

9. The method according to claim 1, wherein the at least one phosphonium cation is present at a concentration of greater than 0.2 mol/L in the electrolyte.

10. The method according to claim 1, wherein the electrolyte is substantially free of organonitrogen cations or comprises any organonitrogen cations in a combined amount of less than 0.1 mol/L.

11. (canceled)

12. The method according to claim 1, wherein the proton carrier is a neutral proton carrier selected from the group consisting of an alcohol and an acid.

13. The method according to claim 1, wherein the electrolyte comprises an aprotic donor solvent capable of solvating the metal cations.

14. (canceled)

15. (canceled)

16. The method according to claim 1, wherein the potential at the cathode is below (more negative than) −0.4 V relative to an apparent reduction potential of the metal cation in the electrolyte.

17. (canceled)

18. An electrochemical cell for reducing dinitrogen to produce ammonia, the electrochemical cell comprising:
a cathode;
an anode;
a electrolyte in contact with at least the cathode, the electrolyte comprising:
i) a metal cation selected from the group consisting of lithium, magnesium, calcium, strontium, barium, zinc, aluminium, vanadium and combinations thereof, wherein the metal cation is present at a concentration of greater than 0.5 mol/L in the electrolyte,
(ii) one or more anions comprising at least one negative ion selected from the group consisting of fluorinated sulfonyl imides, fluorinated sulfonyl methides and combinations thereof,
(iii) a proton carrier; and
(iv) optionally, a phosphonium cation,
wherein the combined amount of the metal cation and the optional phosphonium cation is greater than 1 mol/L in the electrolyte;
a source of dinitrogen to supply dinitrogen to the electrochemical cell for cathodic reduction; and
a power supply connected to the cathode and the anode, the power supply capable of applying a potential at the cathode sufficient to reduce the dinitrogen, thereby producing ammonia.

19. The electrochemical cell according to claim 18, wherein the metal cation is present at a concentration of greater than 1 mol/L in the electrolyte.

20. (canceled)

21. The electrochemical cell according to claim 18, wherein the at least one negative ion is selected from the group consisting of fluorinated sulfonyl imides, wherein the fluorinated sulfonyl imides have a structure according to Formula 1: 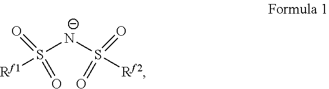
wherein R^{f1} and R^{f2} are independently selected from the group consisting of —F, C₁-C₁₂ perfluoroalkyl and fluoroaryl, or wherein R^{f1} and R^{f2} are connected to form a perfluoroalkylene linker.

22. (canceled)

23. (canceled)

24. The electrochemical cell according to claim 18, wherein the at least one negative ion comprises at least 80 mol % of the one or more anions.

25. The electrochemical cell according to claim 18, wherein the metal cation is lithium.

26. (canceled)

27. The electrochemical cell according to claim 18, wherein the electrolyte is substantially free of organonitrogen cations or comprises any organonitrogen cations in a combined amount of less than 0.1 mol/L.

28. (canceled)

29. (canceled)

30. (canceled)

31. The electrochemical cell according to claim 18, wherein the electrolyte comprises an aprotic donor solvent capable of solvating the metal cations.

32. (canceled)

33. (canceled)

34. (canceled)
